(19) United States
(12) Patent Application Publication
(10) Pub. No.: US 2014/0162239 A1
(43) Pub. Date: Jun. 12, 2014

(54) SYSTEMS AND METHODS FOR INTERACTIVE, REAL-TIME TABLET-BASED TUTORING

(71) Applicant: Mobile Learning Networks, Inc., San Diego, CA (US)

(72) Inventor: John Joshua Roach, San Diego, CA (US)

(21) Appl. No.: 14/105,071

(22) Filed: Dec. 12, 2013

Related U.S. Application Data
(60) Provisional application No. 61/736,542, filed on Dec. 12, 2012.
(60) Provisional application No. 61/736,554, filed on Dec. 13, 2012.
(60) Provisional application No. 61/736,556, filed on Dec. 13, 2012.
(60) Provisional application No. 61/736,557, filed on Dec. 13, 2012.

(51) Int. Cl. G09B 5/12

(52) U.S. Cl. CPC G09B 5/125
USPC 434/350

(57) ABSTRACT

A peer-to-peer tutoring system is provided for use between touch screen portable electronic devices. The system provides a dynamic, real-time interactive session between a tutor and a student using a virtual whiteboard, real-time messaging and voice communications. The system also provides a full capture and review of sessions for future review by students and parents. The portable electronic devices exchange data in near real-time via a connection with a central server that acts as both an exchange mechanism to push, pull and manage session data, both current and historical. A tutor selection application allows students and parents to review tutors, review and create tutor ratings and create and manage appointments with tutors.

### BACKGROUND

1. Technical Field

Described herein is a peer-to-peer tutoring system that may be implemented on a touch screen portable electronic device which allows for a dynamic, real-time interchange session between a tutor and a student, as well as a full capture and review of sessions by students and parents. The portable electronic devices exchange data in near real-time via connection with a central server that acts as both an exchange mechanism to push, pull and manage session data, both current and historical.

### SUMMARY OF THE INVENTION

The embodiments described herein are directed to a peer-to-peer tutoring system that may be implemented on a touch screen portable electronic device which allows for a dynamic, real-time interchange session between a tutor and a student, as well as a full capture and review of sessions by students and parents. The portable electronic devices exchange data in near real-time via connection with a central server that acts as both an exchange mechanism to push, pull and manage session data, both current and historical.

Students and tutors can each draw on a sophisticated virtual whiteboard interface, exchange messages and photos, and talk in real-time. They can both simultaneously draw on the whiteboard, exchange text messages, open up new pages on the whiteboard, upload and display images, draw on top of the images and cut/copy/paste amongst the various pages and whiteboard during the session.

Students initiate sessions, either dynamically in real-time or by scheduling a future session (that day, later in the week . . . etc.). Students can choose from a list of tutors, including from a ‘favorites’ list, who's currently available, or randomly, based on a tutor's ranking Students may sign up and choose from a selection of categories/subcategories of interest, for instance “8th grade math—Pre-Algebra.”

Tutors sign up, and also choose their specialties from amongst the same list of categories/subcategories. Tutors can be crowd-sourced, or chosen based on rankings, recommendations from friends, from a list of favorite tutors from past sessions, or purely based on current availability and specialty.

The sessions are recorded to provide a playback mode which allows the student or parent to review the session at any time. The review can be run at regular speed (1×) so a 30 minute session review would take 30 minutes. The review can also be fast forwarded, or run at 2×, 4×, or 8× to more quickly review the session.

The students may be charged through a third party online payment system, such as an Apple App Store account or PayPal account, and the tutors may be paid through an online banking account such as PayPal.

In one aspect of the invention, a real-time tablet-based peer-to-peer tutoring system, comprises: a student touchscreen device configured with an interactive display interface; a tutor touchscreen device configured with the interactive display interface; and a server configured to transmit interactions with the interactive display interfaces between the student touchscreen device and tutor touchscreen device in real time; wherein the interactions include voice communication input to the student touchscreen device and tutor touchscreen device and physical inputs to the interactive display interfaces.

In another aspect of the invention, a method of real-time tablet-based peer-to-peer tutoring, comprises the steps of: initiating an interactive real-time tutoring session between a student touchscreen device configured with an interactive display interface and a tutor touchscreen device configured with the interactive display interface; transmitting interactions between the interactive display interface of the student touchscreen device and the tutor touchscreen device in real time using a server; wherein the interactions include voice communication input to the student touchscreen device and tutor touchscreen device and physical inputs to the interactive display interfaces.

Additional aspects related to these embodiments will be set forth in part in the description which follows, and in part will be apparent from the description or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. Specifically:

FIG. 1 illustrates a system of peer-to-peer tutoring between two tablet devices, according to one embodiment of the invention;

FIG. 2 illustrates a flow chart of a tutoring session, according to one embodiment of the invention;

FIG. 3 illustrates a flow chart of user data flow in setting up and initiating a tutoring session, according to one embodiment of the invention;

FIGS. 4A-4Q illustrate the workflows of a tutoring session between the student and the tutor, according to one embodiment of the invention;

FIG. 5 illustrates a whiteboard interface of how the users are able to interact with the whiteboard to zoom in and out of content, according to one embodiment of the invention;

FIGS. 6A-6N illustrate user interface screens of the tutoring system, according to one embodiment of the invention; and

FIG. 7 illustrates a block diagram of an embodiment of a computer/server system upon which an embodiment of the inventive methodology may be implemented.

### DETAILED DESCRIPTION OF THE INVENTION

In the following detailed description, reference will be made to the accompanying drawings. The aforementioned accompanying drawings show by way of illustration, and not by way of limitation, specific embodiments and implementations consistent with the principles of the present invention. These implementations are described in sufficient detail to enable those skilled in the art to practice the invention, and it is to be understood that other implementations may be utilized and that structural changes and/or substitutions of various elements may be made without departing from the scope and spirit of the invention. The following detailed description is, therefore, not to be construed in a limited sense. Additionally, the various embodiments of the invention as described may be implemented in the form of software running on a general purpose computer in the form of a specialized hardware, or combination of software and hardware.

### I. System Overview

The embodiments described herein are related to a peer-to-peer tutoring system that may be implemented on a touch screen portable electronic device which allows for a dynamic, real-time interchange session between a tutor and a student on separate portable electronic devices, as well as a full capture and review of sessions by students and parents. The portable electronic devices exchange data in near real-time via connection with a central server that acts as both an exchange mechanism to push, pull and manage session data, both current and historical.

In one embodiment, the portable electronic devices are tablet computers with touch screen interfaces that allow the tutor and the student to dynamically interact through natural movements, such as handwriting, drawings, voice and messaging. The tablets may therefore be equipped with hardware (such as a camera or microphone) and software which help the users achieve these interactions. In the examples provided below, an Apple® iPad® is used, although any portable electronic device with a touch input interface may be used as long as it includes the necessary hardware and software to carry out the described features. The tutoring system may be run as an application on each portable electronic device, and may be configured with features and interfaces designed for each specific user—the tutor, the student, the parent or a system administrator. In one embodiment, the tablets would be connected over a network, such as the Internet or a local area network (LAN), so they can communicate with each other in real-time to convey the information between the student and the tutor in real-time during a tutoring session. In another embodiment, the devices may be wirelessly connected with each other over a peer-to-peer connection between the two devices, such that a network is not needed.

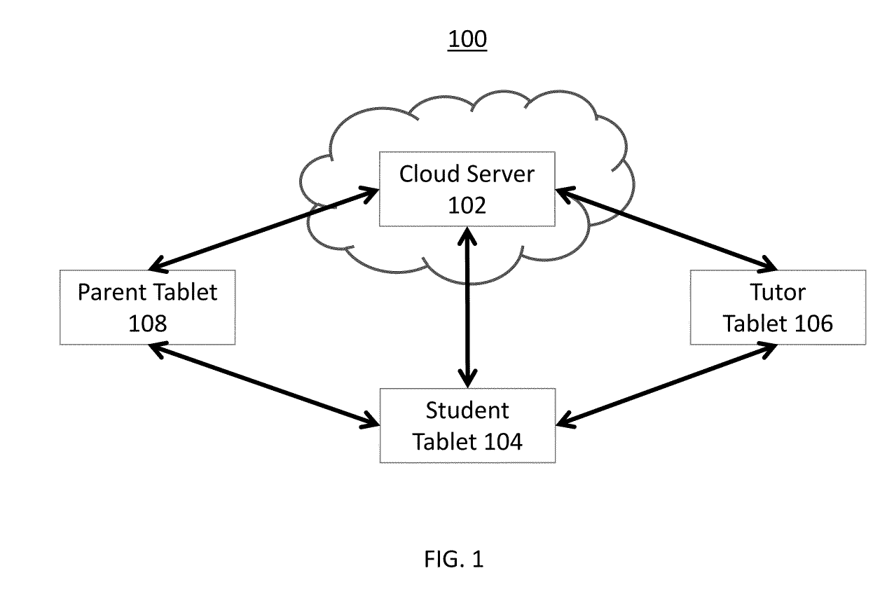

One embodiment of the tablet-based tutoring system 100 is illustrated in FIG. 1, which illustrates a cloud server 102 which communicates with a plurality of portable electronic devices, including a student tablet 104, a tutor tablet 106 and a parent tablet 108. As described above, the portable electronic devices may communicate with the cloud server 102 or directly with each other depending upon the type of communication and the network.

### Start Session

A tutoring session involves a student with a student tablet and a tutor with a tutor tablet interacting in real-time using an application on the tablet which allows the student and tutor to talk, work on a shared whiteboard user interface and exchange pictures or videos. The student arrives for the lesson, along with the tutor, by initiating the application. A live ‘session’ is started where all back and forth interactions are transmitted between student and tutor in real-time, including the voice data and the shared whiteboard, pictures, etc. In addition to those live interactions, the system will also determine: 1) that the student arrived at the session and when; 2) that the tutor arrived at the session and when; and 3) when they each leave the session. This information may be put into a report to let the parent or the system administrator know whether the student or the tutor is late or whether the session ended prematurely and why. All aspects of the session may be recorded for later playback or viewing, including the voice data, shared whiteboard, pictures, etc. These settings may be adjusted as needed.

### Session Notifications

Parents, students and tutors will all receive notifications when sessions are about to start or when they have been scheduled. These include, optionally: notify 30 minutes before start of session; notify 15 minutes before; notify 5 minutes before; notify when student arrived; notify when tutor arrived; notify when student left; and notify when tutor left. Each of the above can adjust their settings.

### Organizational Structure of Tutoring Sessions

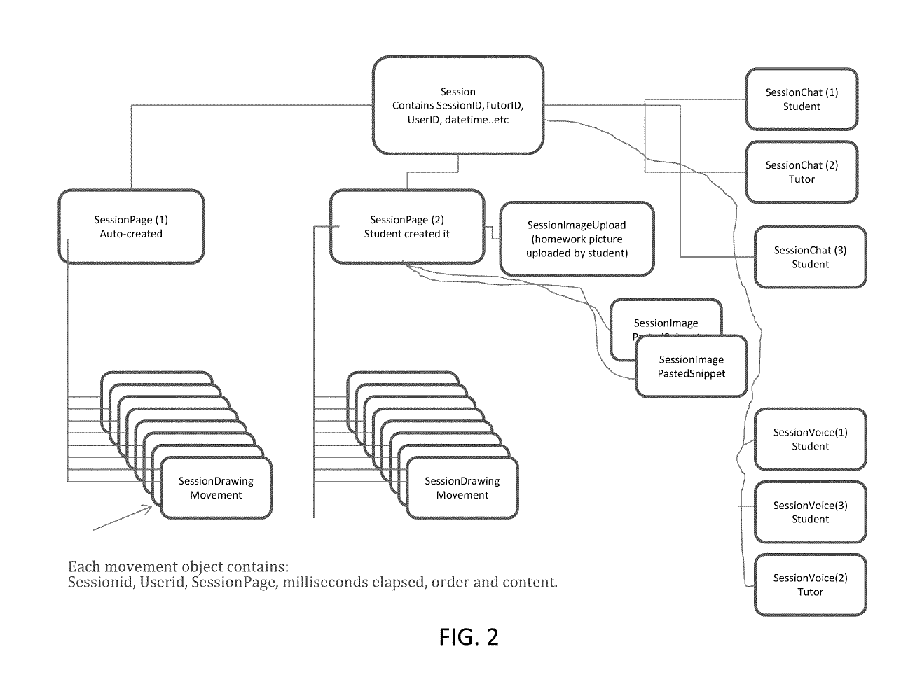

FIG. 2 is a block diagram illustrating the organizational structure of a tutoring session 100, where various session pages are created automatically 102 or by the student 104, including the ability to upload images 106 to the session and cut and paste snippets 108 of the images to focus on a particular selection of text in the uploaded images. Session chats 110 may also be used where the student and tutor exchange messages during the session, and voice sessions 112 will be initiated between the student and the tutor to allow them to talk in real time during the tutoring session. The tutoring session also captures drawing movements on the interactive shared whiteboard as movement objects 114 so that each notation on the whiteboard by the student or tutor is captured and stored. Each movement object 114 contains a Session ID, User ID, SessionPage, milliseconds elapsed, order and content in order to properly store and organize the whiteboard annotations during the session.

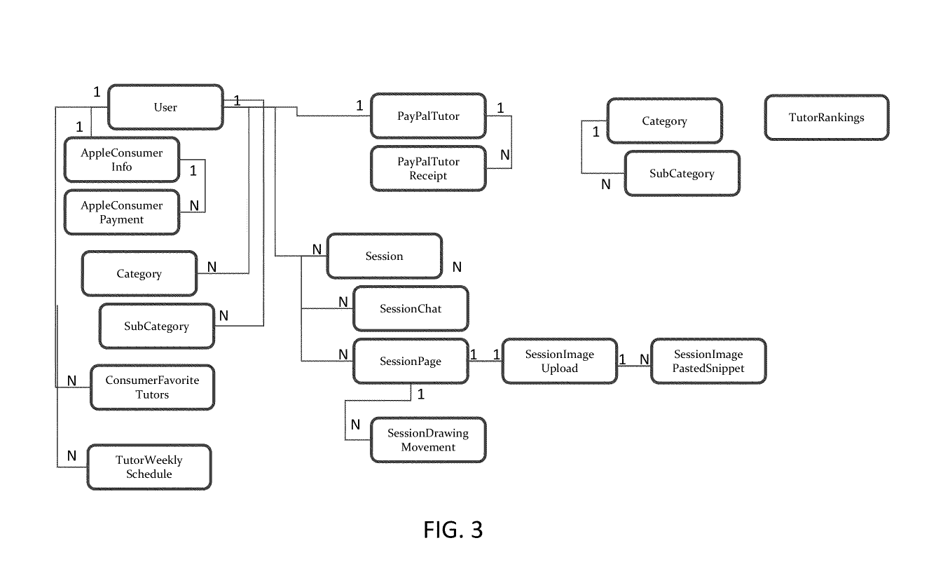

FIG. 3 is a block diagram illustrating the organization of the features and interfaces provided by the system for the users. The user 302 (student or parent) may be provided with options to store payment information 304 using an existing account profile managed by a service provider for the portable electronic device, such as a user's Apple® profile with stored payment information that the user utilizes for services through the Apple® App Store®. The user 302 also can create a favorite tutors list 306 with the tutors that they prefer to use, and the user is also provided with an online schedule 308 where they can manage the scheduled tutoring sessions and search for new appointments by tutor, by subject, etc. The tutor may be paid through an online payment system such as PayPal® using a payment interface 310, and the tutor may be given a receipt 312 to track their payments.

The session interface 314, which was previously described in FIG. 2, will include session chats 316, session pages 318 on the interactive whiteboard, image uploads 320, image snippets 322 to be pasted on the whiteboard, and any movements 324 made on the whiteboard.

Category 326 and subcategory features 328 provide for the selection of subjects and tutors, as will be described below. The system also provides for the ranking of tutors 330 by the users, including ratings and reviews, so that the users can evaluate the tutors and select those most appropriate for their student.

### Session Setup and Execution Workflows

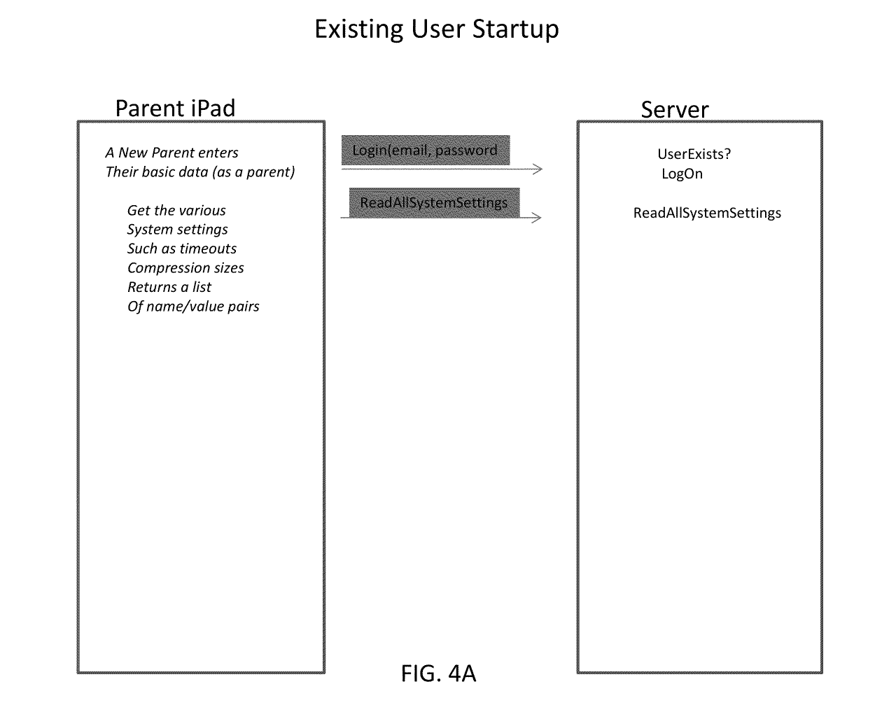

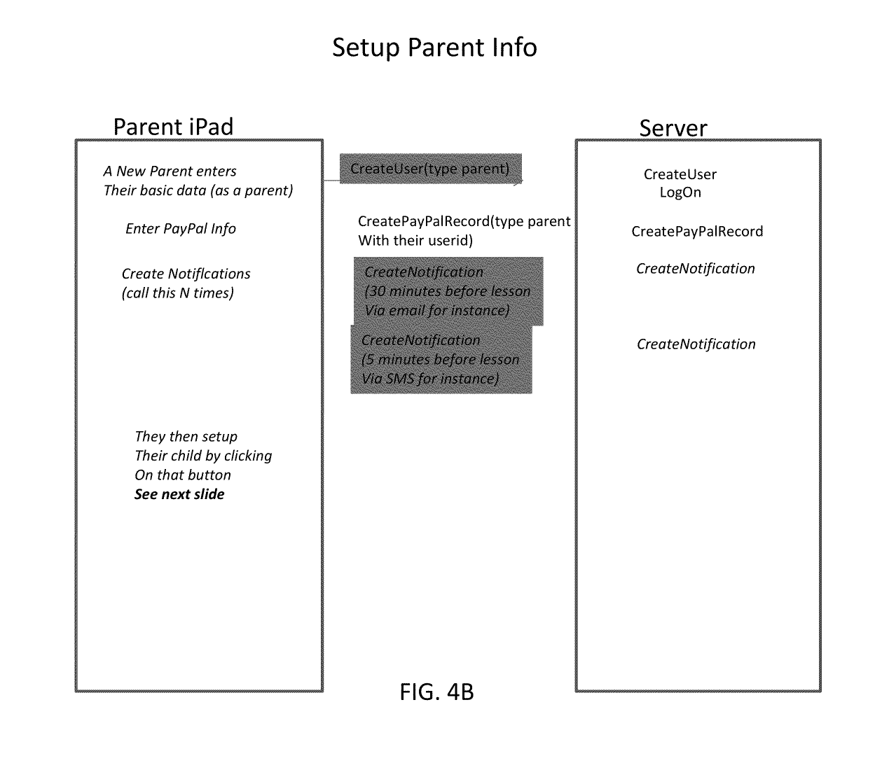

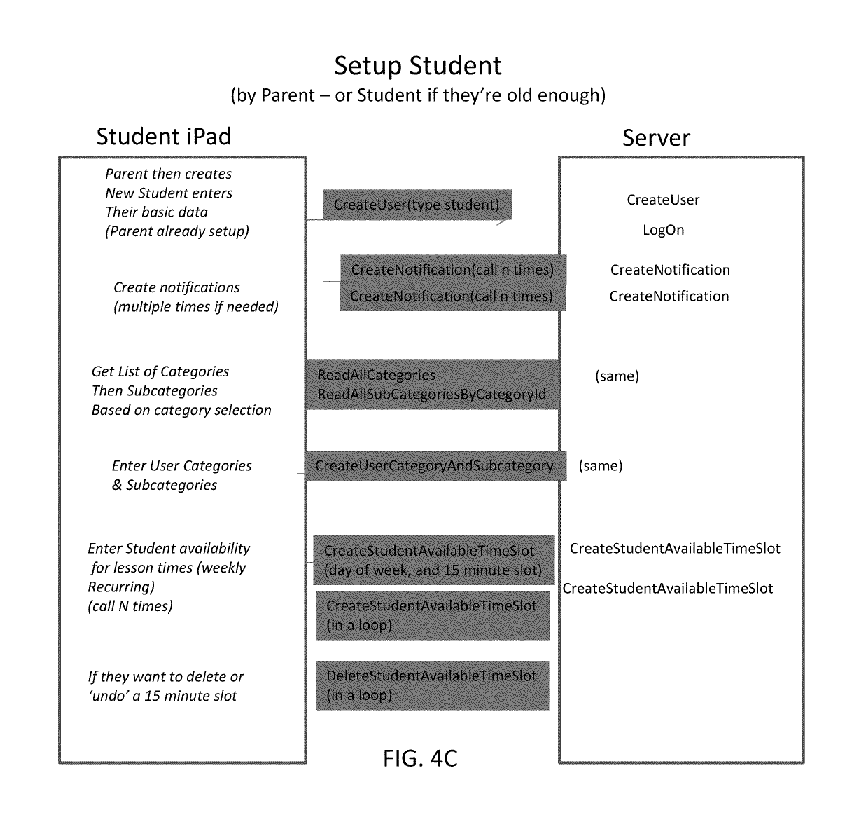

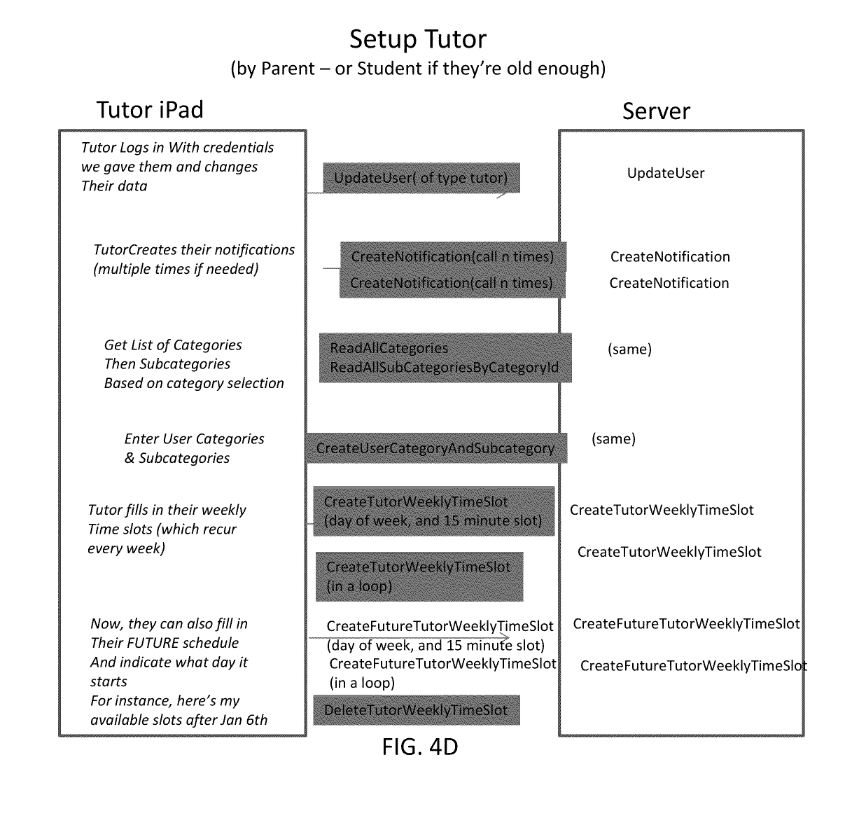

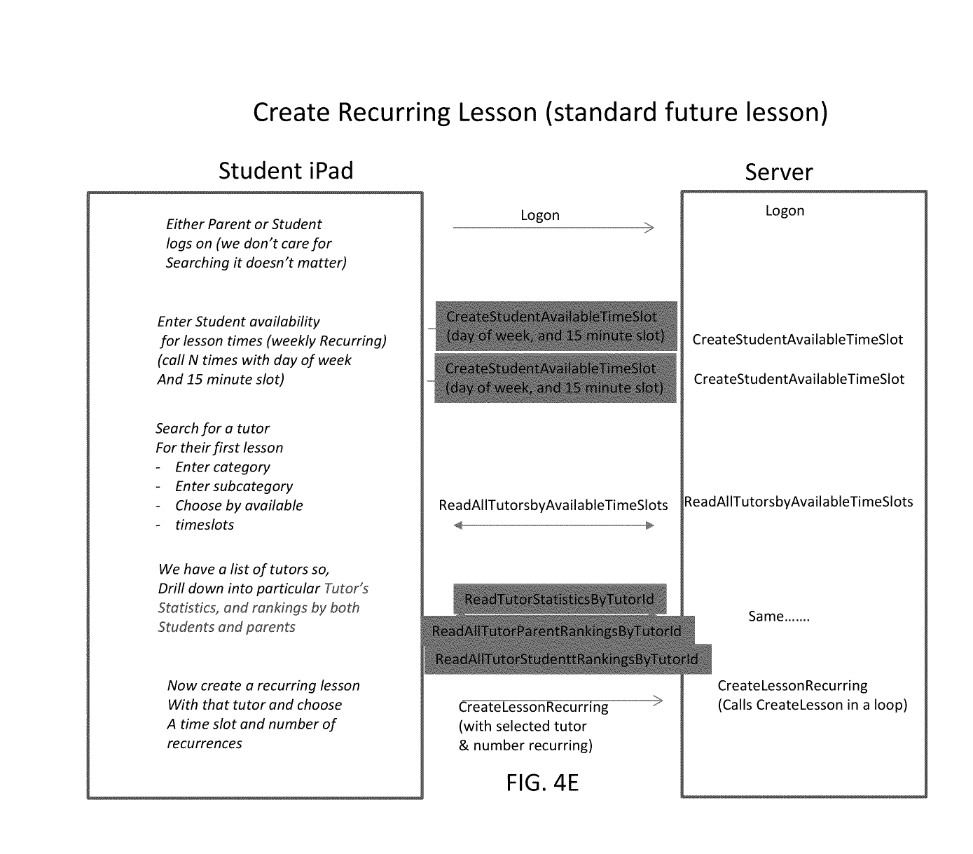

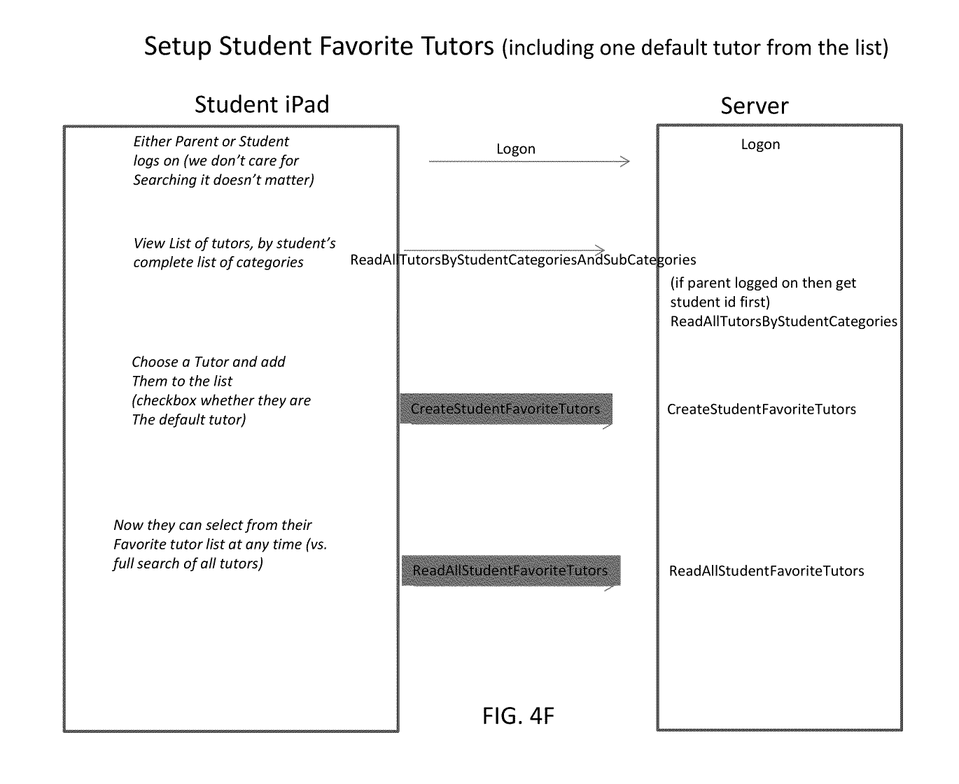

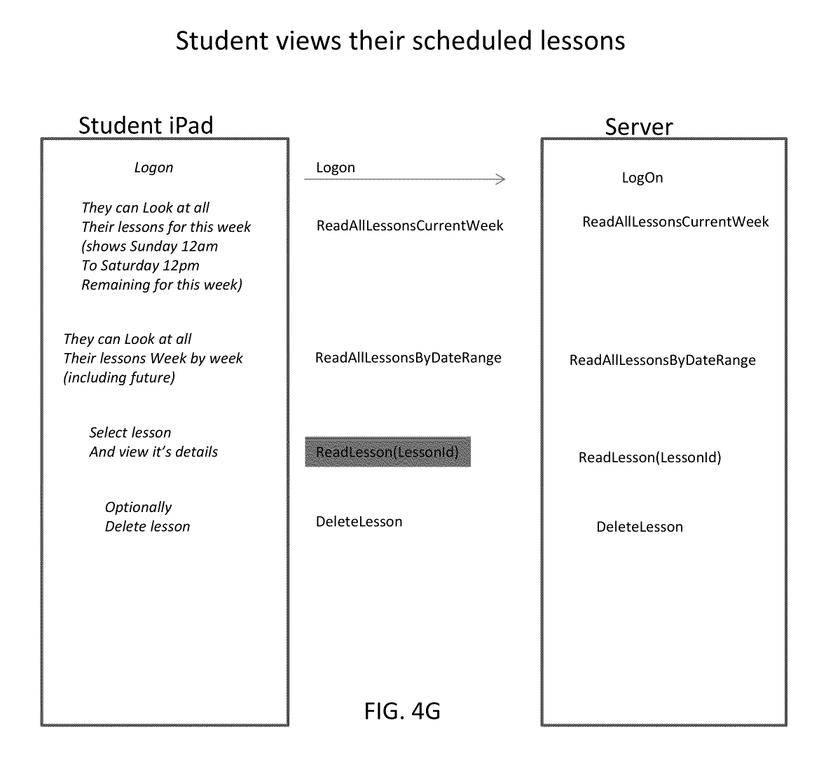

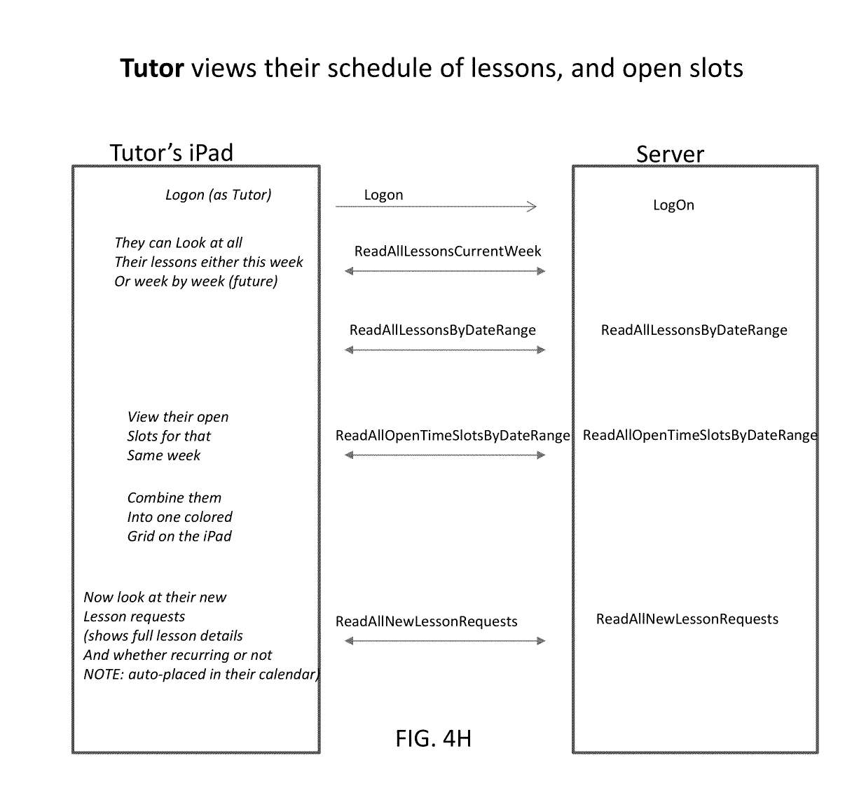

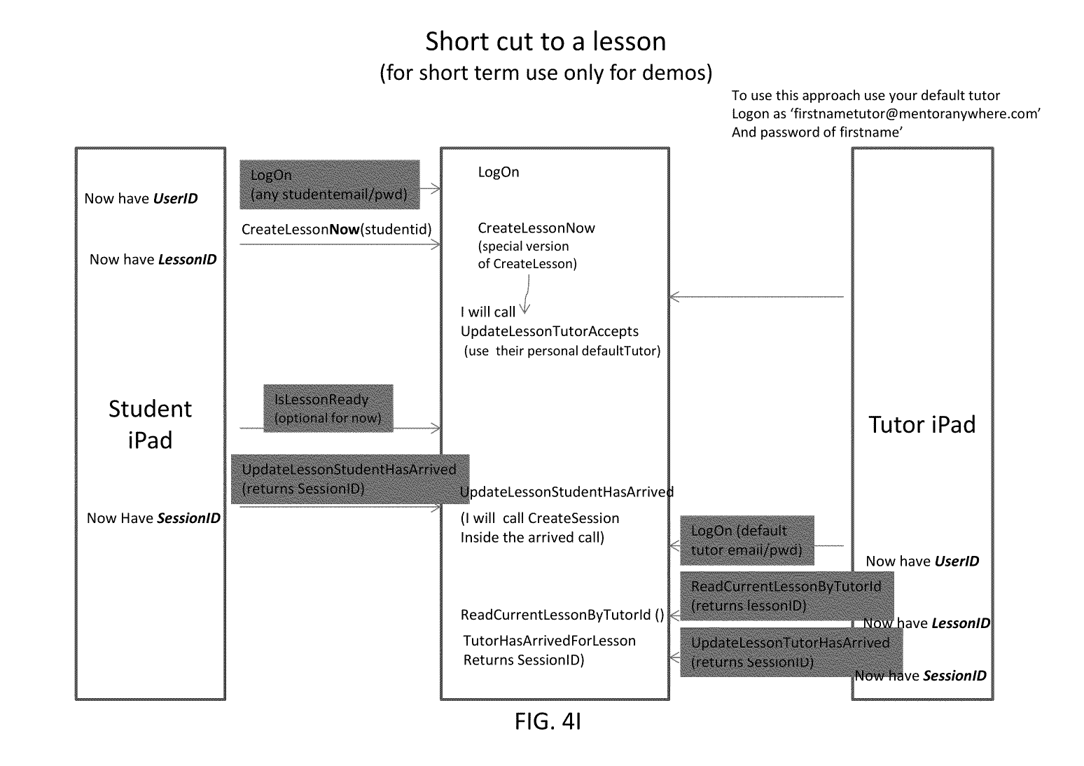

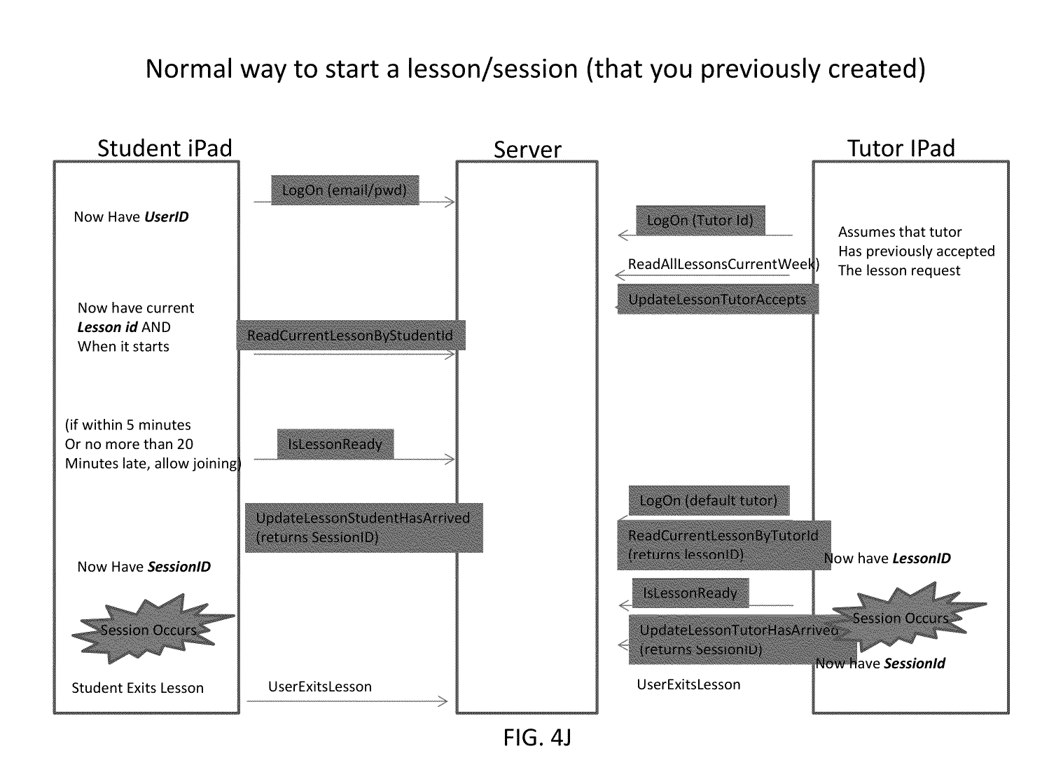

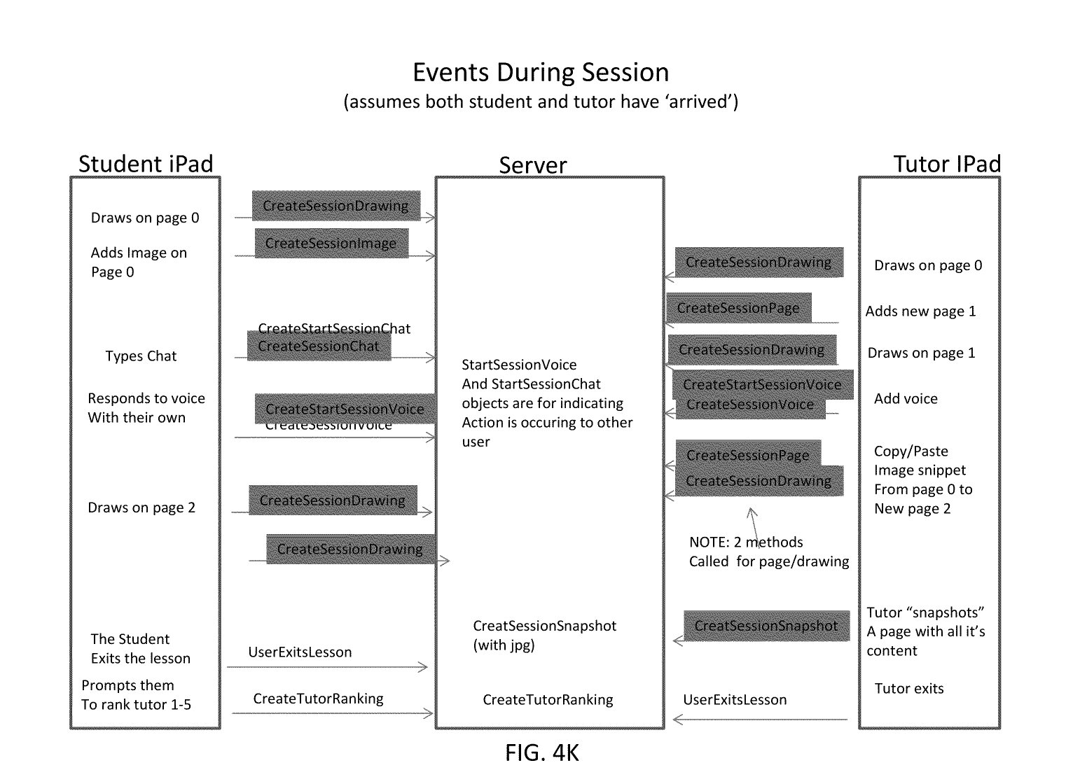

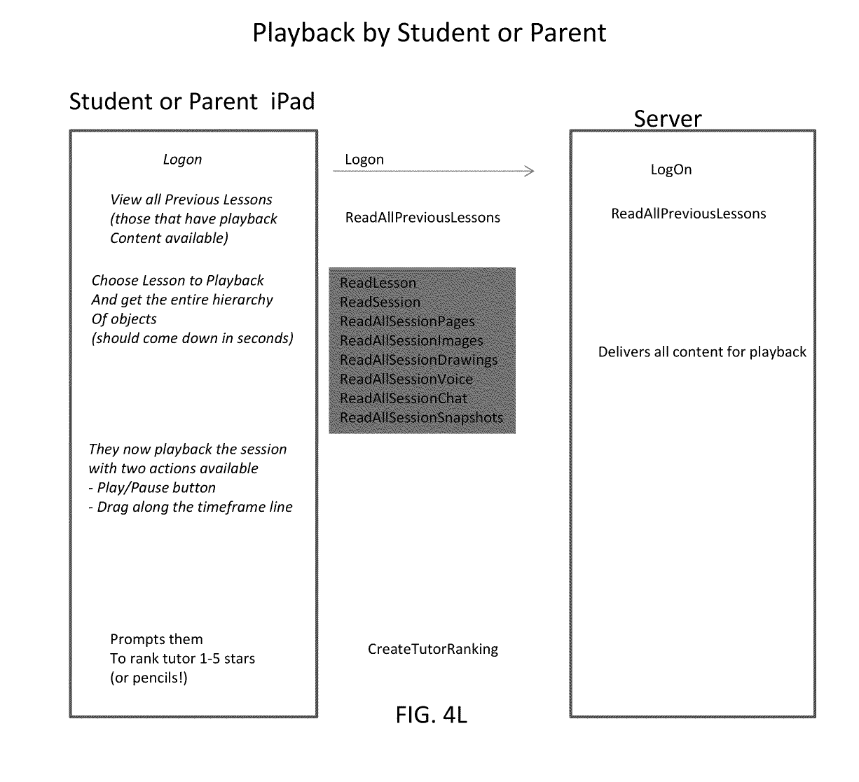

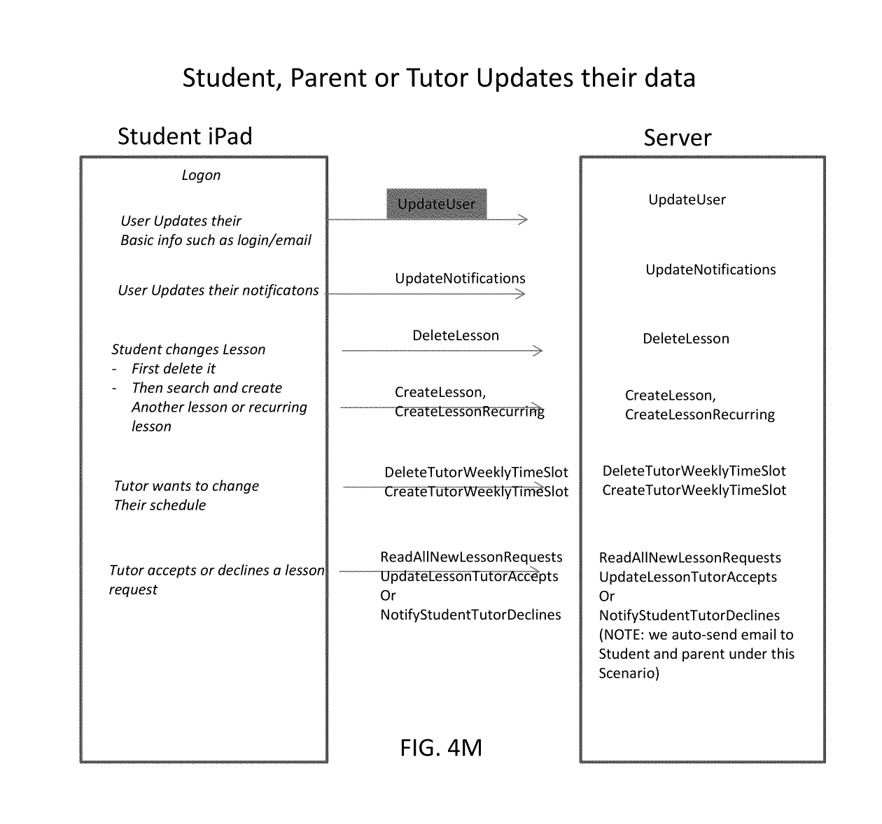

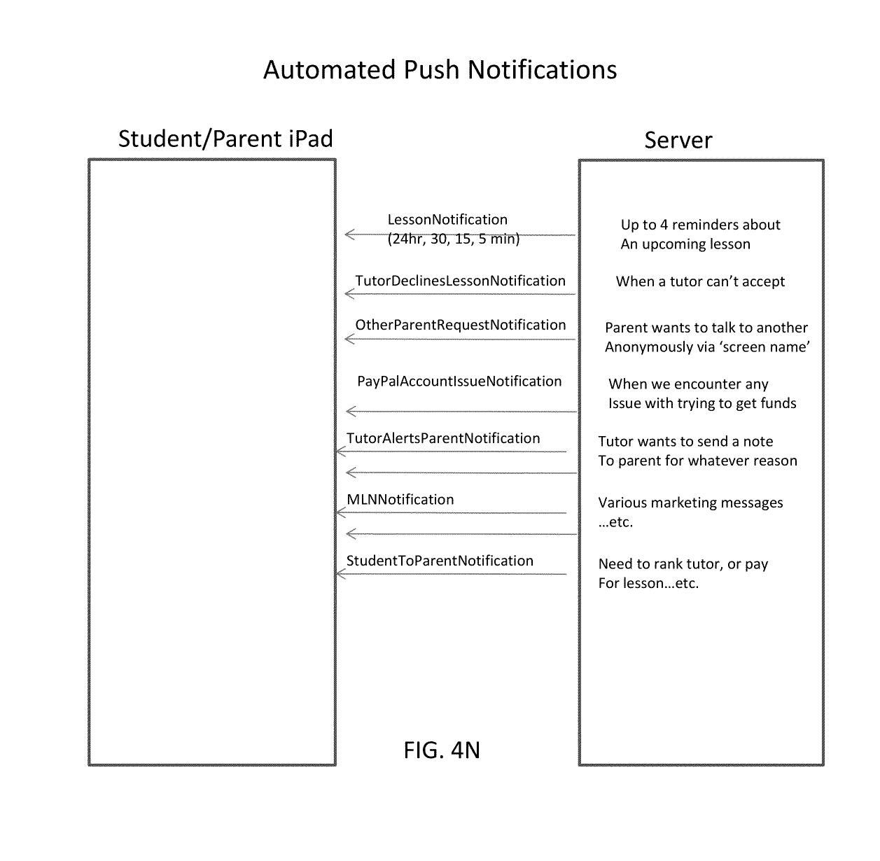

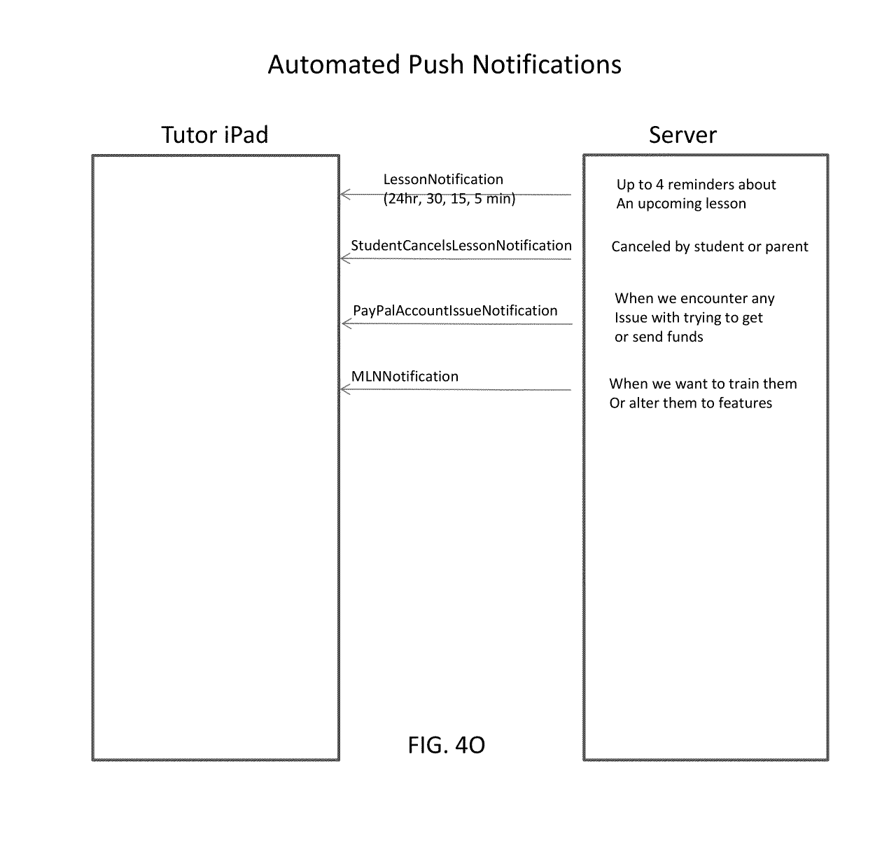

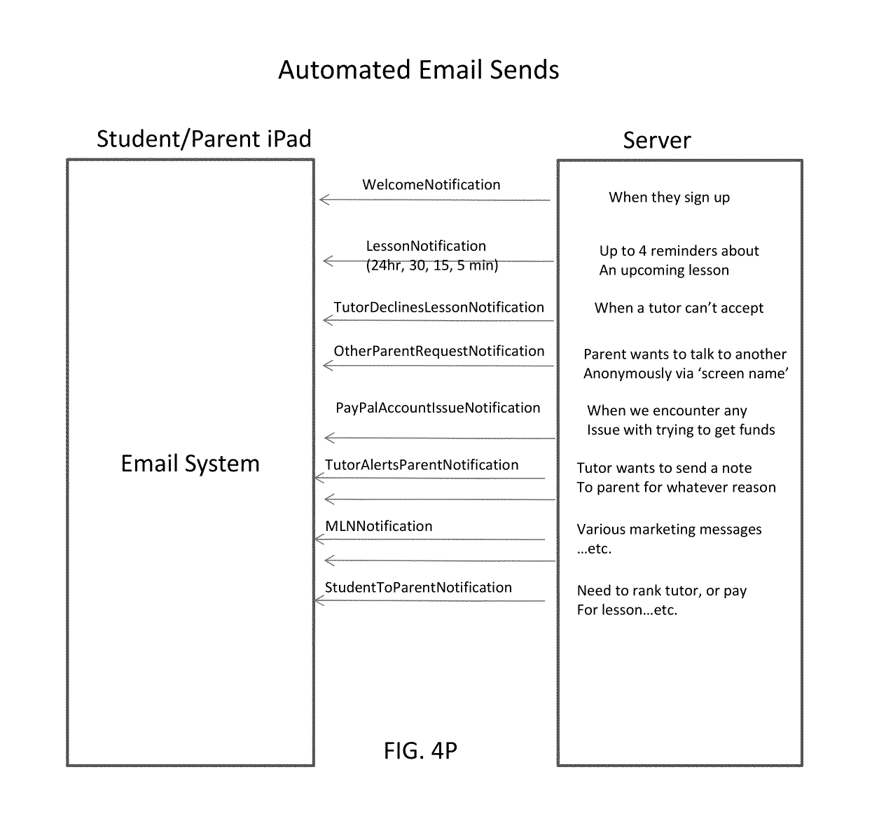

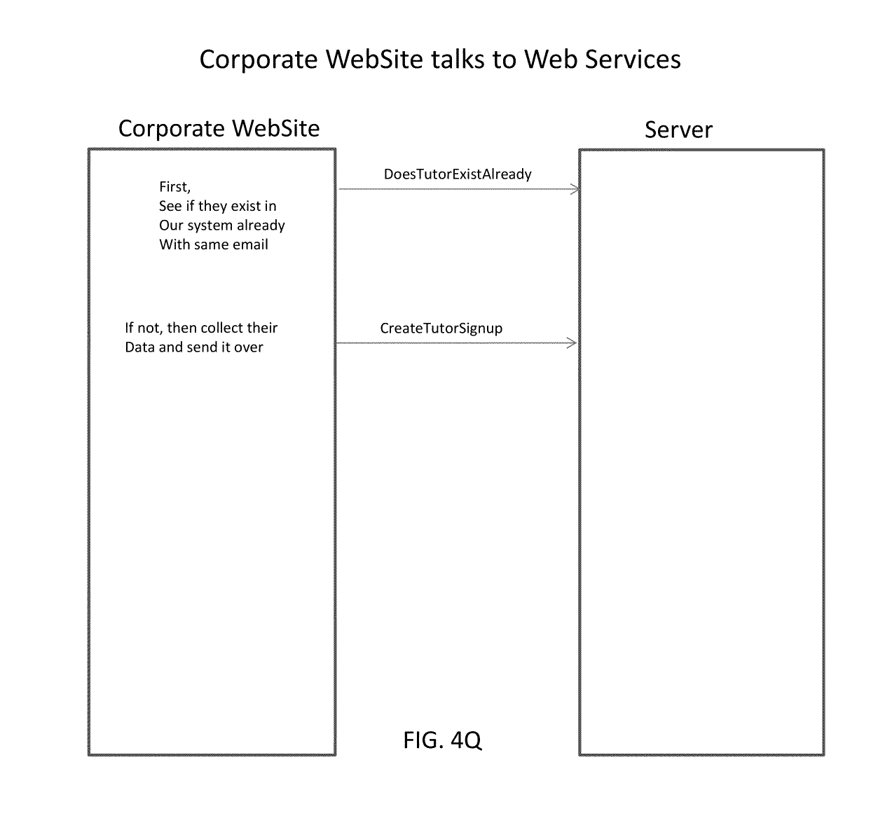

The workflow of creating the user and tutor accounts, scheduling sessions and initiating a tutoring session is illustrated in FIGS. 4A-4Q in terms of the communication steps between the tablets and the server. In one embodiment, the setup, scheduling, management and notifications for the parent may be provided to a third portable electronic device for the parent so that the parent and student can each have separate devices on which they interact with the system. For example, the parent may interact with the system via a smartphone to schedule sessions, receive alerts and review completed sessions, notes and tutor remarks while the student interacts with the system using his/her own tablet. This will provide additional convenience for the parent and the student since the parent can remotely manage the sessions from a separate device and location.

FIG. 4A illustrates the user setup communication 400 between a parent tablet 402 and the server 404, where the user enters profile information and creates a username and password. In FIG. 4B, the parent enters payment information to provide for automatic payment for the sessions directly to the tutor and creates notification settings for when they want to be reminded about the sessions. In FIG. 4C, a student tablet 406 is used to create the student profile, including the subjects the student needs help in, the student's schedule and availability for tutoring and notifications settings. In FIG. 4D, the tutor tablet 408 is used to setup the tutor profile, subjects which they teach in and their schedule of availability. The schedule for the student and the tutor can therefore be automatically matched by the system when the student is searching for a tutoring session so that the student only sees the tutors that are available at the times the student is available and for the subjects they need. FIG. 4E illustrates a process of creating a recurring lesson with a tutor from the student tablet 406, while FIG. 4F illustrates the steps for a student to select their favorite tutors and create a favorite tutors list. In FIG. 4G, the process for a student to review their tutoring schedule is provided, while FIG. 4H illustrates the process for a tutor to review their tutoring schedule. In FIG. 4I, the shortcut process for initiating a tutoring session if the session was previously unscheduled is shown, where the student tablet 406 uses their user ID to generate a lesson ID for the lesson after which the tutor tablet 408 communicates the tutor's user ID and lesson ID with the server 404 to initiate a session ID for the tutoring session. FIG. 4J illustrates a second process for initiating the tutoring session that was previously scheduled, where the student tablet 406 and tutor tablet 408 have previously communicated with the server to accept the session appointment and the specific exchange of the user ID, lesson ID and session ID is done within a certain time period prior to the session starting.

FIG. 4K illustrates the workflow of data between the student tablet 406, server 404 and tutor tablet 408. The workflow illustrates how the student can create drawings, submit images, send chats, voice, etc. to the server which is then transmitted to the tutor tablet 408. The tutor is responsible for creating the session page that is submitted to the server for the overall tutoring session, but the tutor can also create drawings, submit images, send chats, voice, etc. The student or tutor can also create drawings or submit images to different pages within the session drawing. The tutor may also create a session snapshot which captures all of the content of a particular session page or all pages of the session for further review by the student or parent at a later date.

FIG. 4L illustrates the workflow for playback of a previously recorded tutoring session on either the student tablet 406 or parent tablet 402. The playback mode allows for the pages, images, drawings, voice, chat and snapshots to all be transmitted from the server 404 to the tablet. The student or parent tablet may also be prompted to rate the tutor during the playback session.

FIG. 4M illustrates the workflow for the student to manage their profile, schedule and other account information, including lessons, login, and communication with the tutors regarding scheduling. FIGS. 4N and 4O illustrate the push notifications that may be transmitted from the server to the student tablet 406, parent tablet 402 and the tutor tablet 408. The notifications may be reminders of upcoming sessions, monitoring alerts that sessions have started or were canceled, and other notifications regarding scheduling or payments. FIG. 4P illustrates additional communication that may be done via e-mail between the server and the tablets, which mirror the notifications shown in FIGS. 4N and 4O. FIG. 4Q illustrates a workflow for system administration between an administrative computing device and the server 404 to manage the tutors which participate in the system to determine if they have a profile or enroll them with the system.

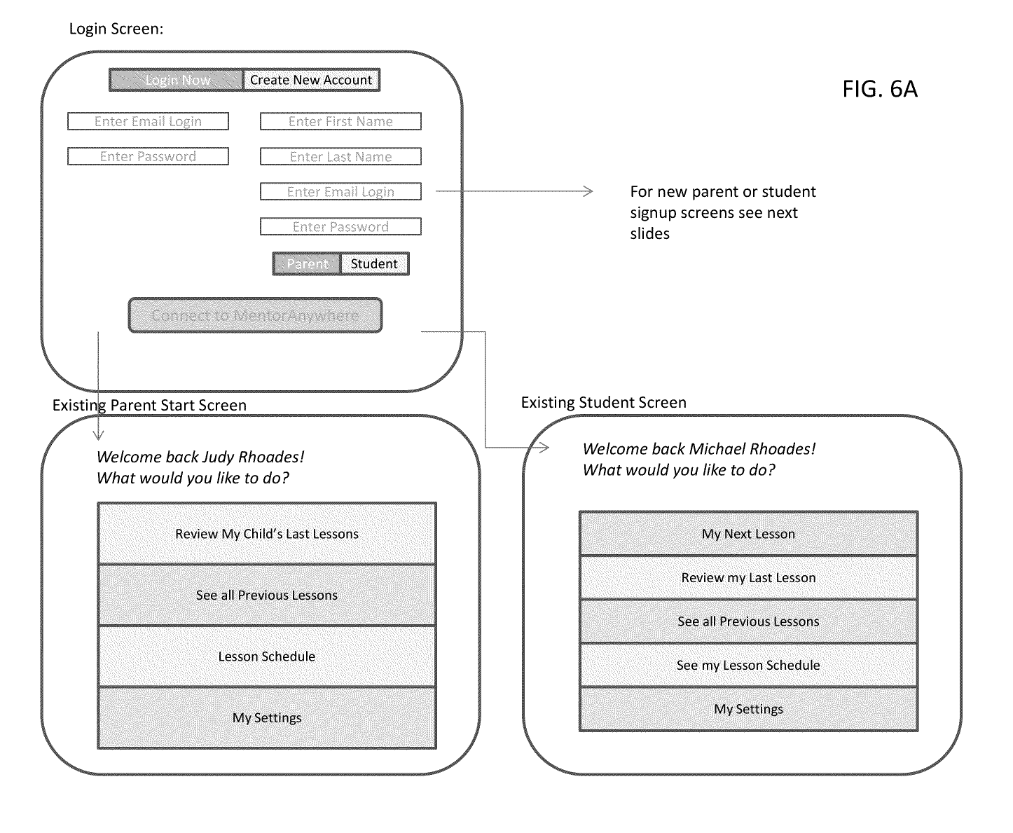

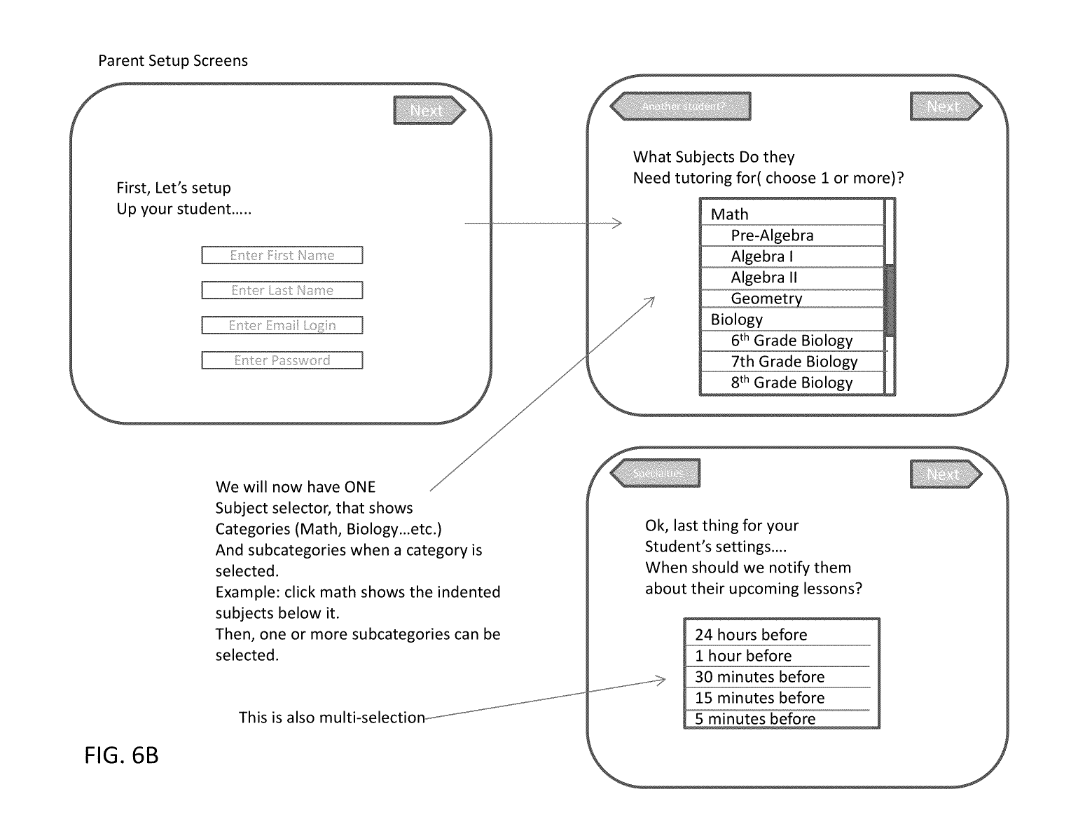

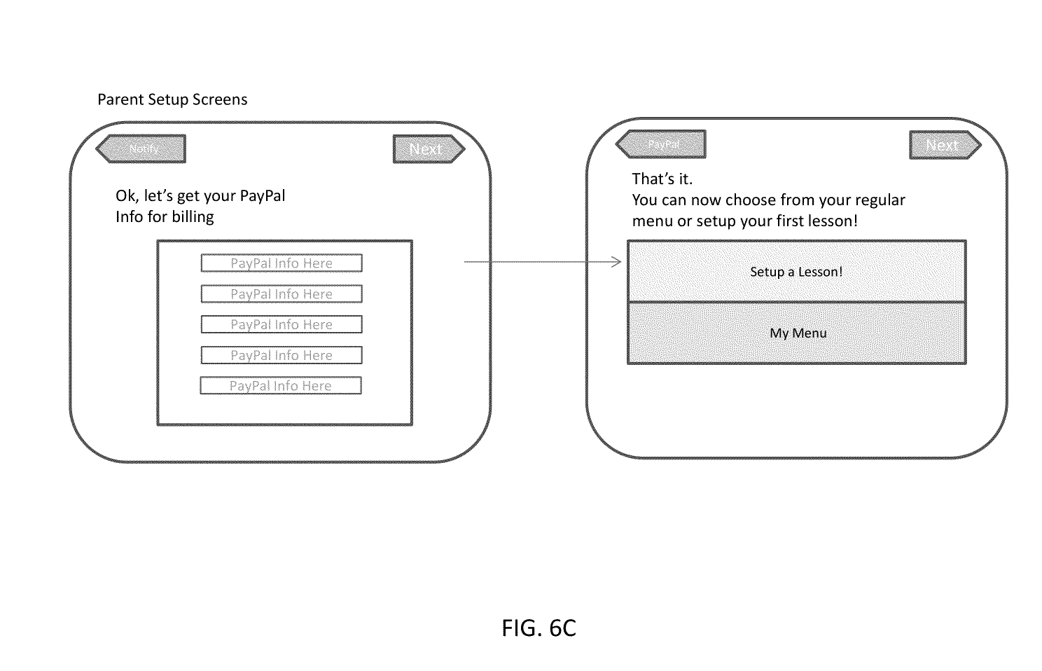

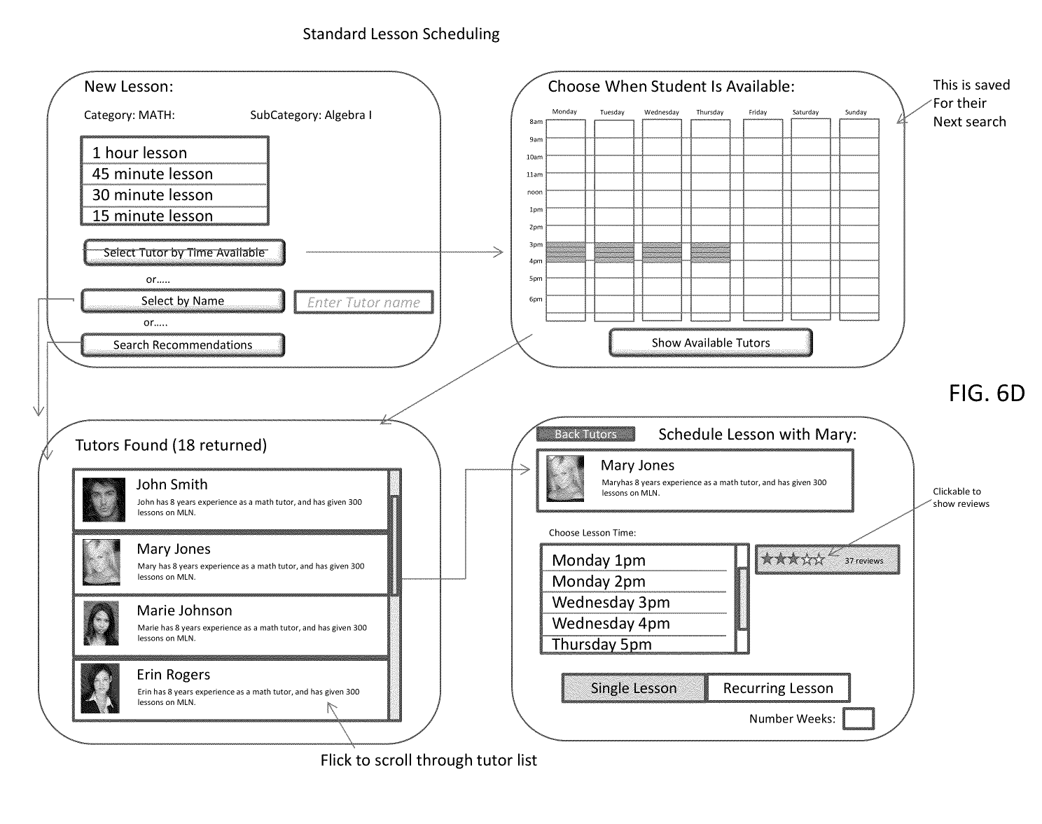

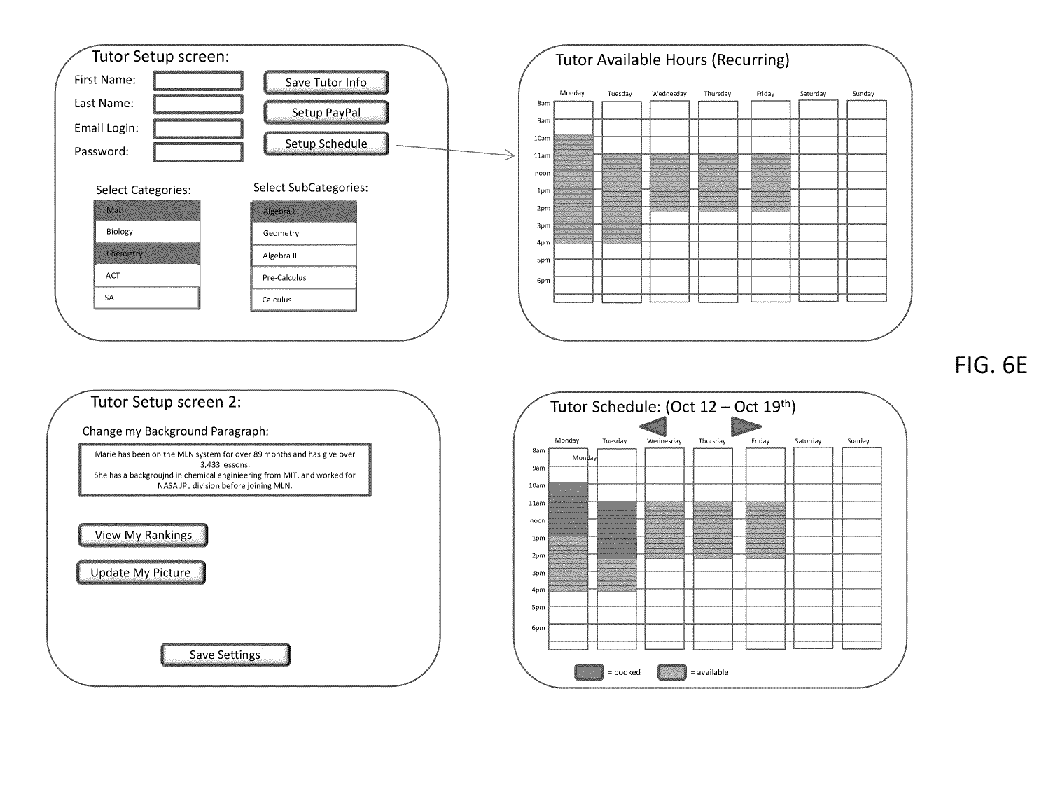

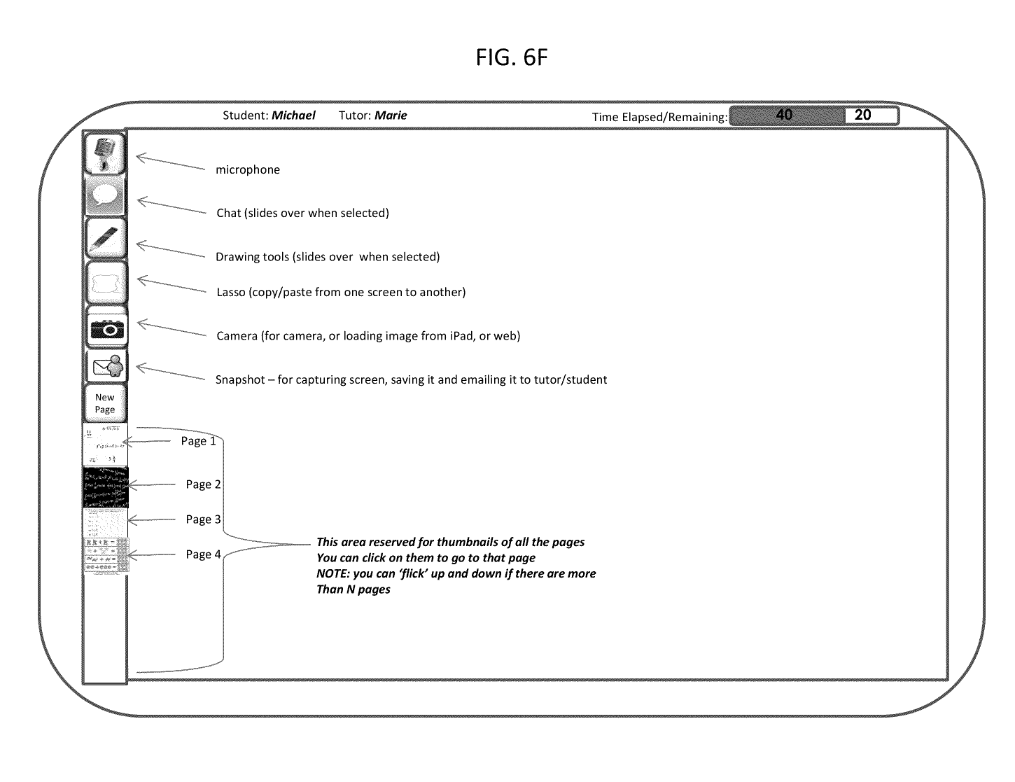

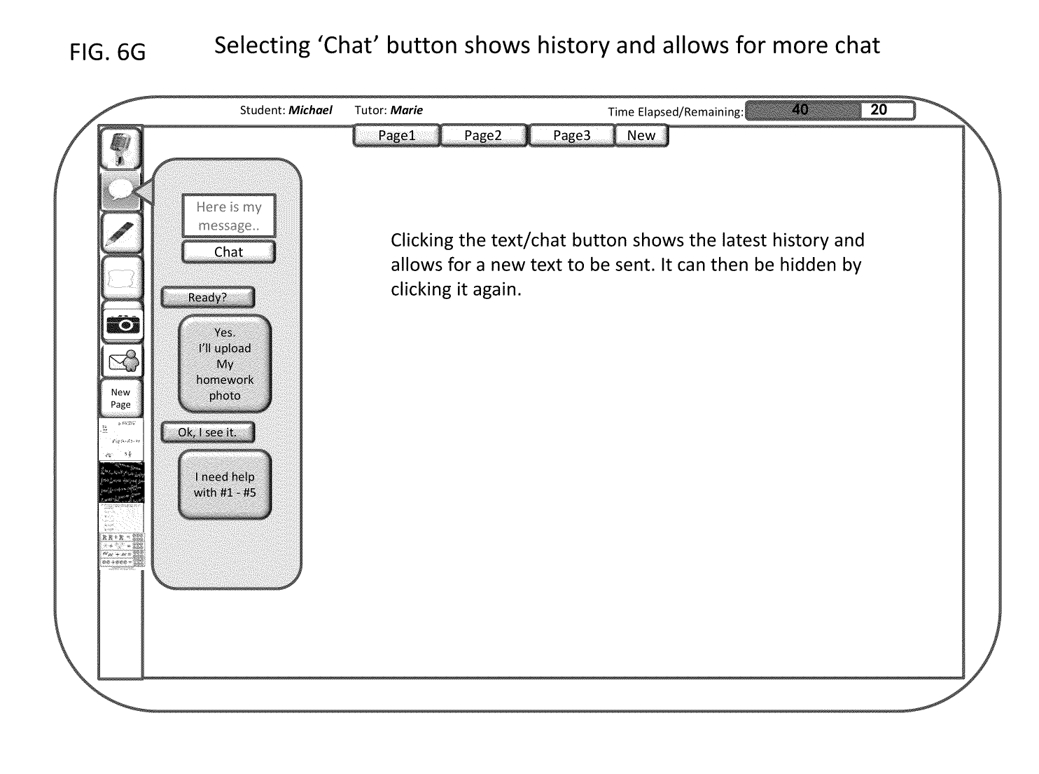

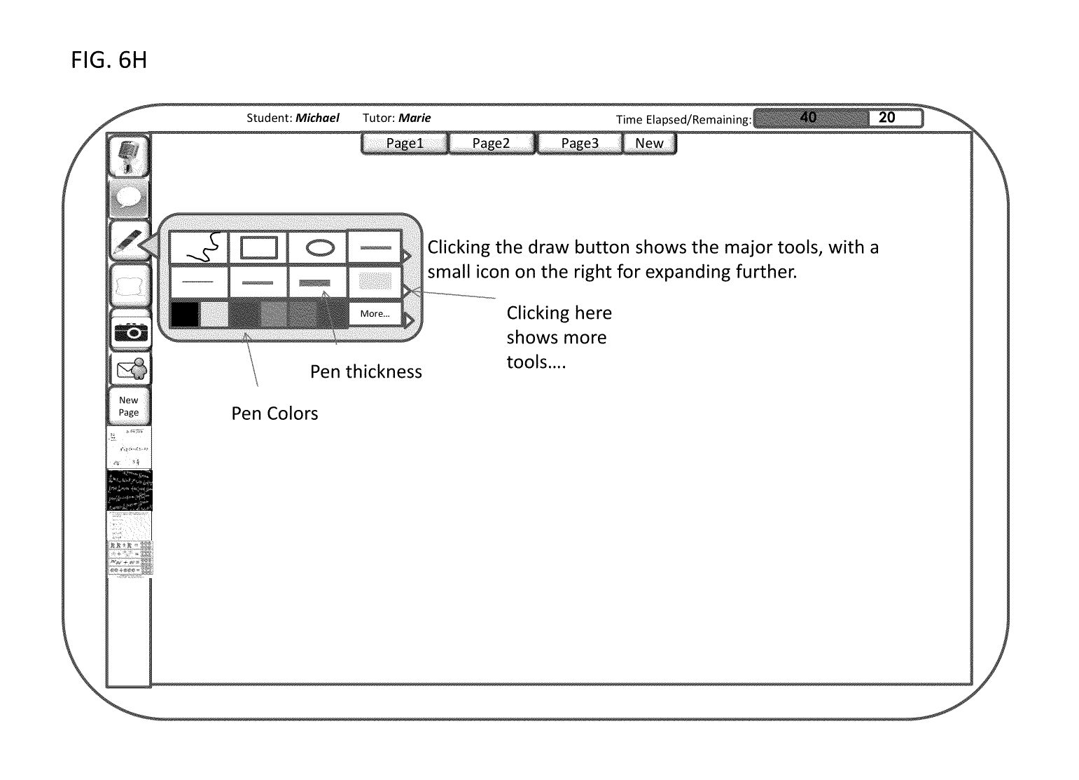

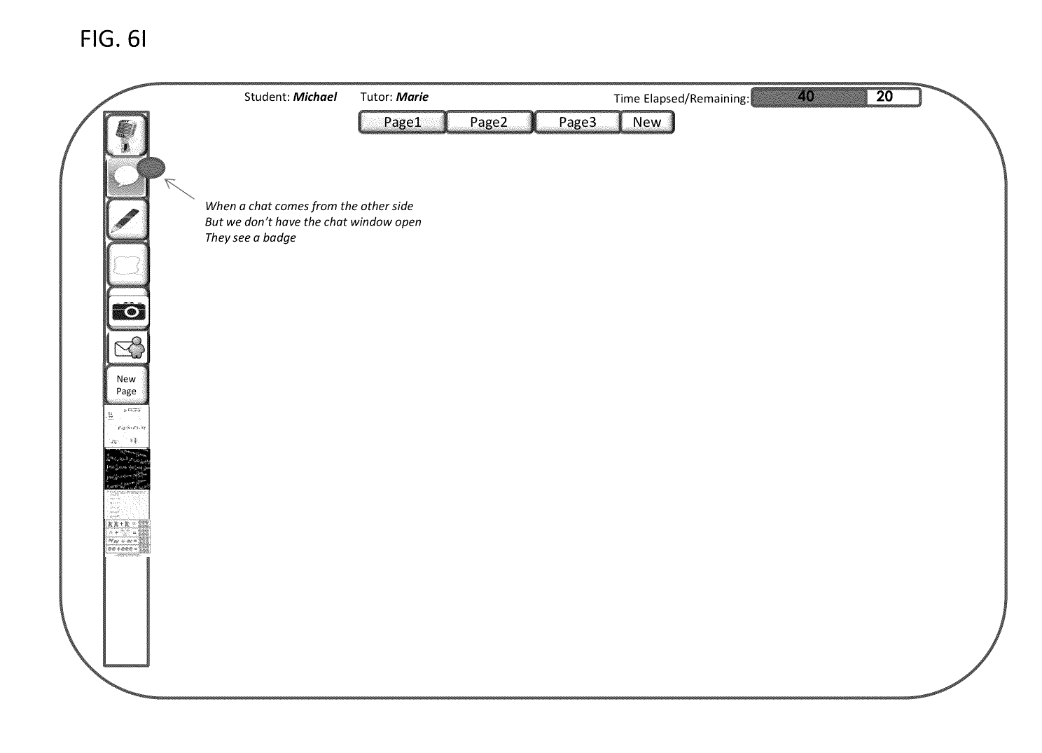

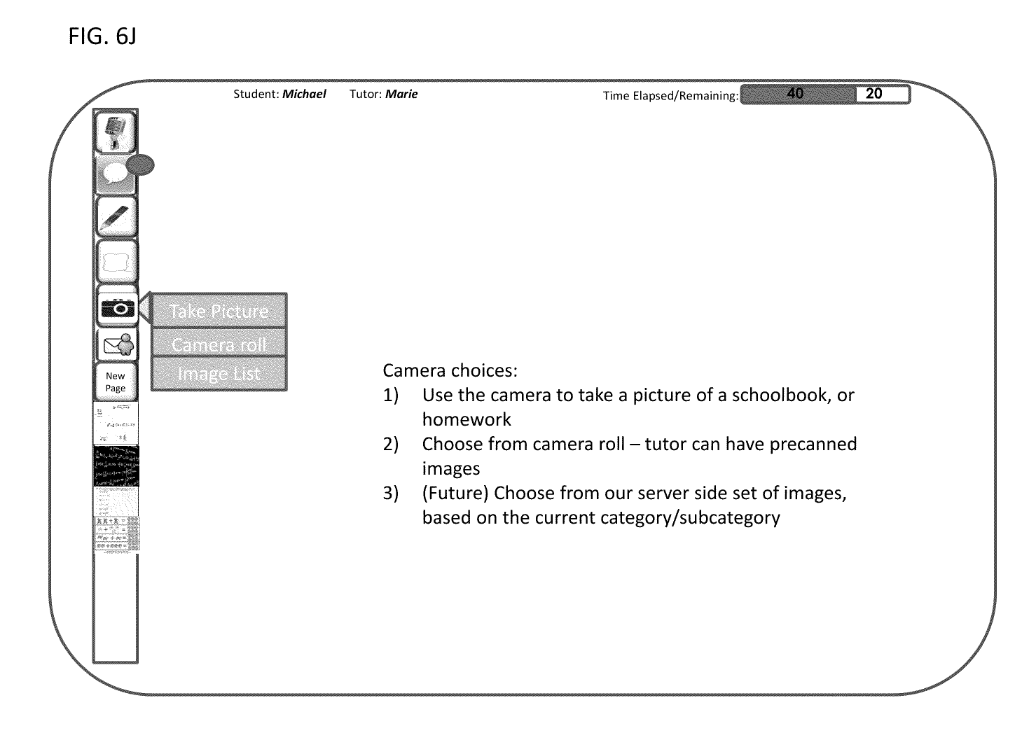

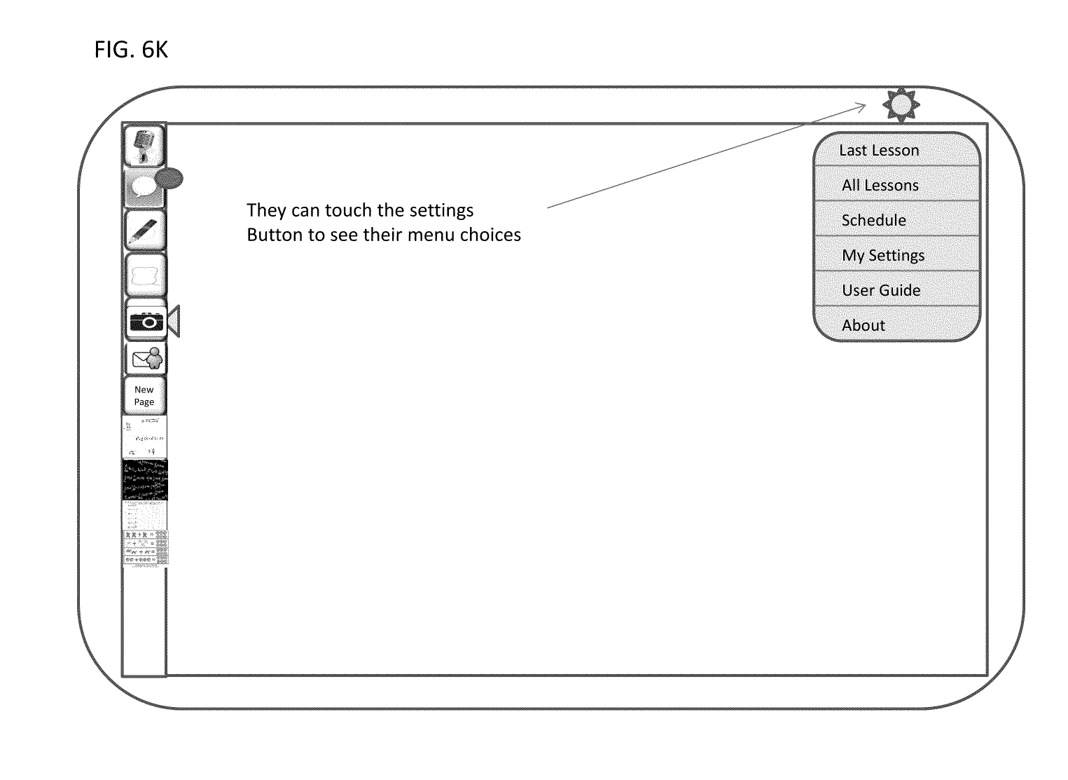

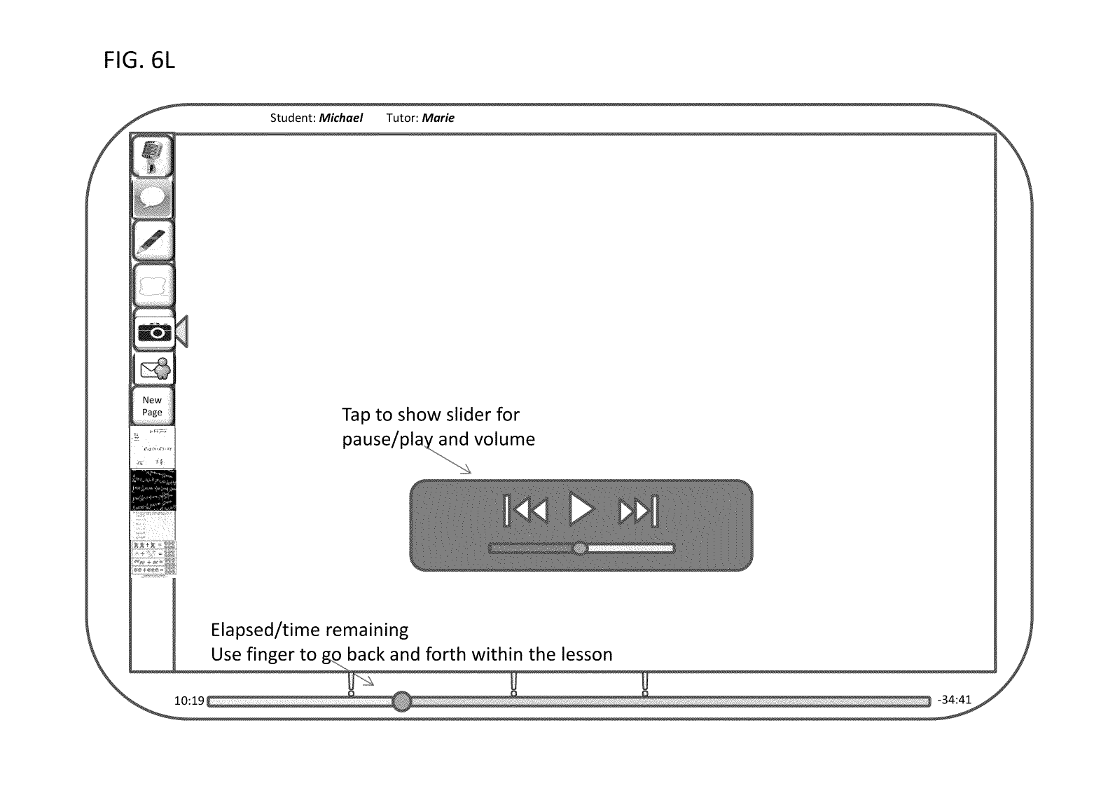

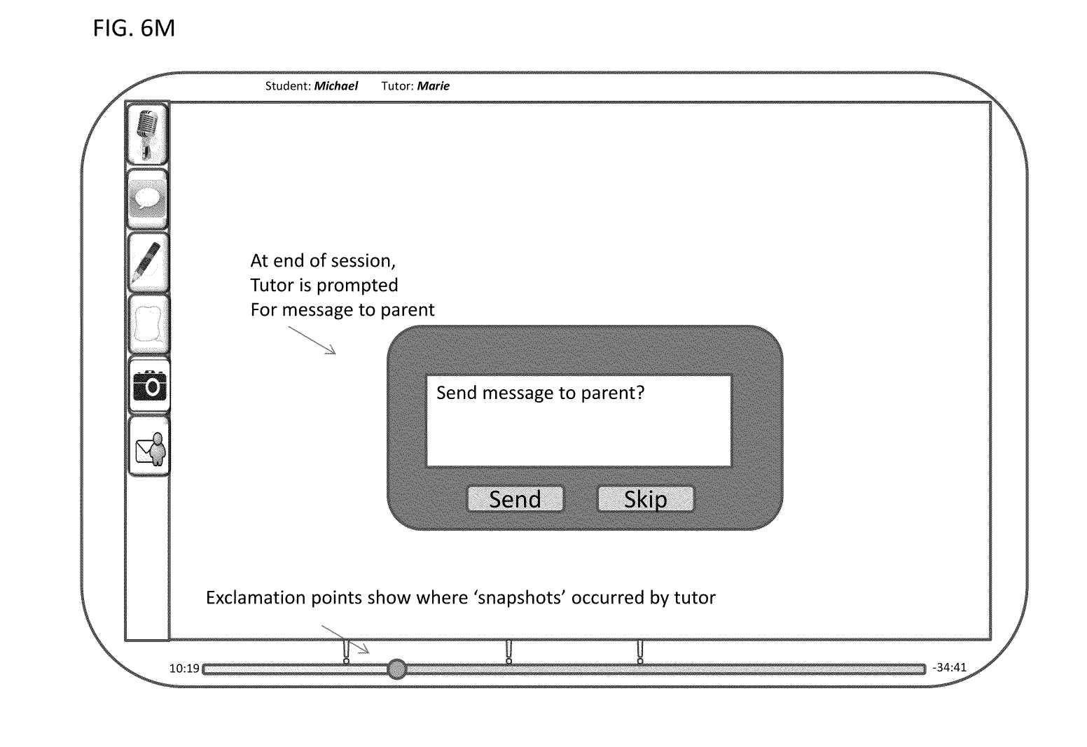

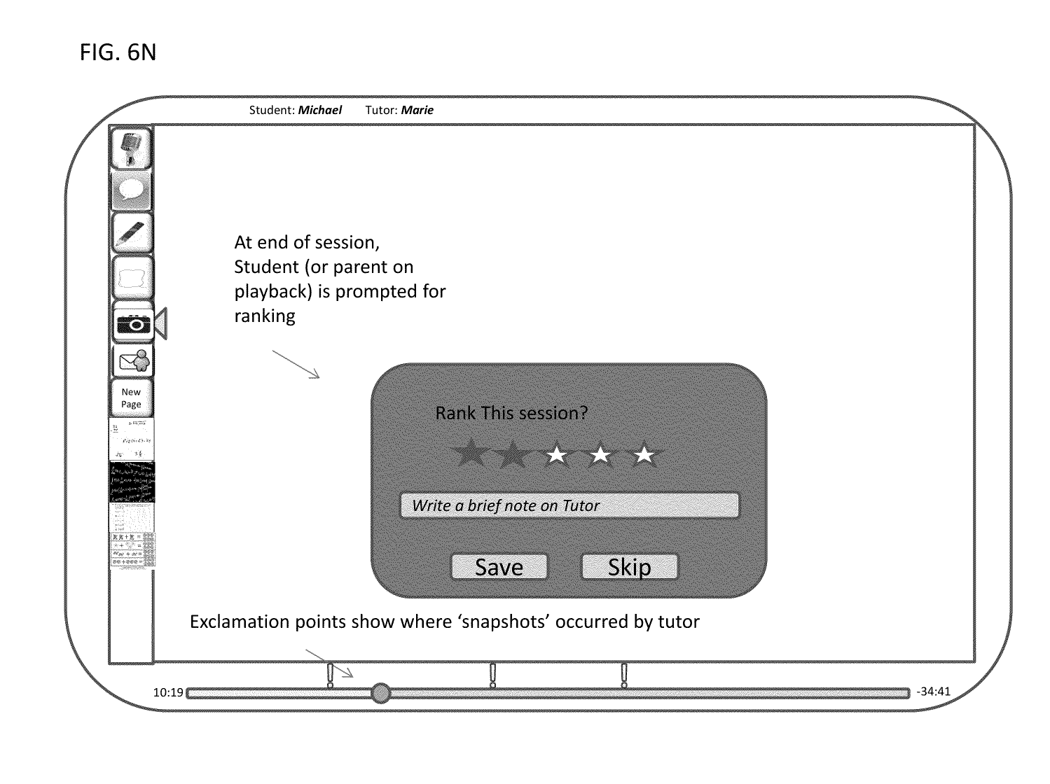

FIGS. 6A-6E illustrate several graphical user interfaces (GUIs) provided to a parent or student for setting up user profiles, setting up lessons and selecting a tutor using the scheduling system. FIG. 6A illustrates the setup GUIs and menus, while FIG. 6B illustrates the GUIs for selecting subjects and session notifications and FIG. 6C illustrates the payment setup GUIs. FIGS. 6D and 6E illustrate the detailed scheduling GUIs for selecting the time, dates and tutors for the tutoring sessions, where the user can review the tutor profile, reviews and select single or recurring lessons.

FIGS. 6F-6N illustrate GUIs of the collaborative shared whiteboard and the various features available for the tutoring session. In FIG. 6F, a menu is provided with options for voice (microphone), chat, drawing, lasso (cut and paste of selected areas), camera (to activate the tablet camera and take a picture), snapshot (to capture the tablet screen content to save for later review, and thumbnails of the different pages created during the session. Basic session information such as the tutor and student name, and a time bar for showing the remaining or elapsed time may be shown.

FIG. 6G illustrates the chat interface, while FIG. 6H illustrates the drawing interface menu, FIG. 6I illustrates a chat notification icon for incoming chats, FIG. 6J illustrates the camera interface, FIG. 6K illustrates a general Settings menu, FIG. 6L illustrates the playback menu and interface, FIG. 6M illustrates a window for the tutor to message the parent, and FIG. 6N illustrates the ratings menu for the student or parent to review the tutor.

### II. Whiteboard Interface

In one embodiment, the student and tutor interact using a dynamic, real-time interactive whiteboard interface which runs as software on the tablet device. The whiteboard provides an interactive space where both users can write, draw, exchange messages, upload and transfer images, capture content, etc. all while seeing what the other user is doing. Users can erase content or create new pages of content, cut and paste between multiple “pages” of the whiteboard, and store portions of images or an entire whiteboard session for future use.

At the start of a session, a blank whiteboard becomes ‘Page 1.’ Other pages can be added at any time by either the student or tutor. The student and tutor can each be on different pages, and there are icons that indicate that the other party is drawing on another page. In one embodiment, a photo can be taken, and the contents (such as a picture of a math book) are automatically used to create the background of another new page. For instance, a student takes a picture of a page of their homework, this is uploaded into the next ‘page,’ and both tutor and student can view the data, draw over it or copy and paste things on top of it.

In one embodiment, the interaction between the student and the tutor during a session will be as follows. The tablets will send up a combination of content, as well as discrete fields for storing in the database. The areas where we will only store iPad content are around the drawing on a page. We will always send up the session id, user id, page id, etc., in the drawing child records, but the context of the drawing object, and movement and interactions on the iPad around drawing will simply be passed over to the other tablet receiving the information with the session id, user id, page id and child record content.

### Zooming

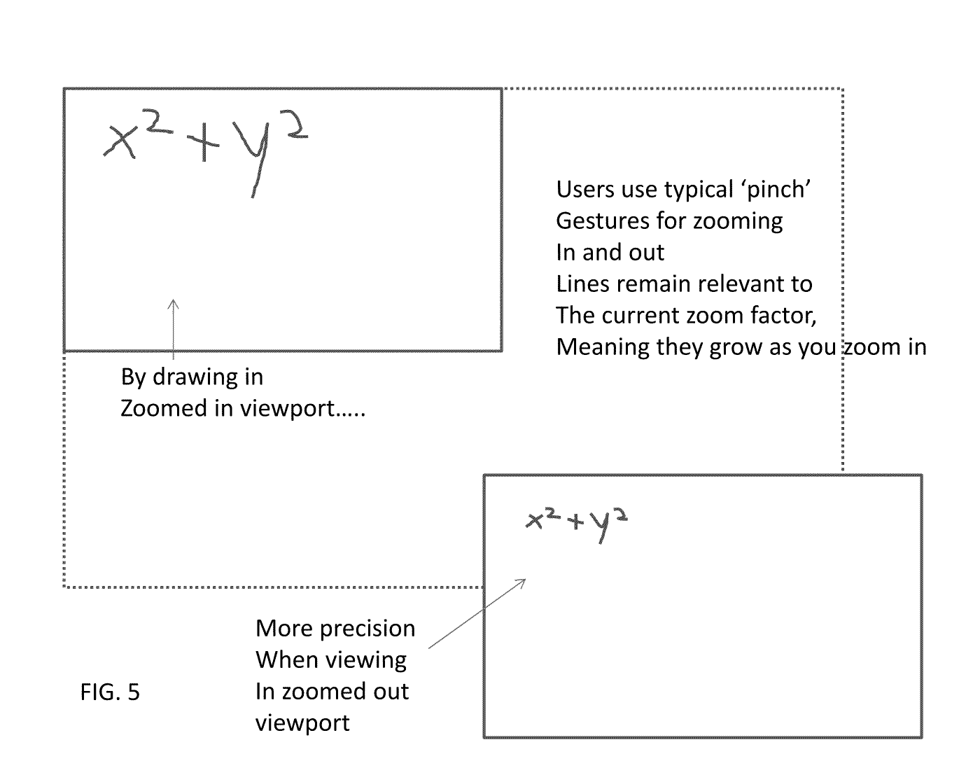

As illustrated in FIG. 5, each user can independently zoom the current whiteboard page they're viewing. For example, the whiteboard display may start at a 1×1 fully ‘zoomed out’ mode, and be zoomed in, via pinch gestures, to a maximum of, for example, 4×4.

Zooming may be allowed on any page by using the pinch-to-zoom functionality on the iPad. Each person, the tutor and student, can independently zoom in an out and draw, allowing for very fine-tuned writing in zoomed in mode. For instance, a student may zoom in before writing “a2+b2=c2,” so that when zoomed out, it appears to have the precision of 12 point font, instead of 20 point font. This allows their finger on the iPad to be much more precise than normal because they can draw whilst zoomed in, then zoom out to printing and viewing.

### Drawing on a Page

When two tablets are communicating during a live session, all the drawing objects of data, voice, images, text chat . . . etc. are sent back and forth and contain the session id, user id, page number, milliseconds from start of session, and order. Beyond those discrete fields is the entire content. All child records of a ‘session’ will contain the above. The parent of the child record is basically the unique page number.

In one embodiment, a central server will favor passing the content as it received it from a first device to a second device, when that device polls it for new content, and once downloaded will mark it as transferred. In the background, it will persist the records to the database for retrieval later for playback.

The drawing tool may provide the following options (menu could be located elsewhere and could have actual shapes vs. text) for shape or drawing type: random line, straight line, square, rectangle, circle, ellipse and thickness. The line width may be drawn narrow or wide, and may be: 1, 4, 8 or 16 pixels. Color options may include a pallet of colors in the form of a grid which the user can select from.

In the whiteboard interface, additional options may include the ability to add a new page, insert an image (either stored on the device or server, or taken with a built-in or peripherally-connected camera) and copy a section of the board and pasting it somewhere else. The copying may provide for the copying of a user-specified shape, such as a rectangle, or the capturing of a section that uses a user-customizable shape which the user may draw with their finger or another input device.

### User Action Indicators

In one embodiment, there may be various indicators that show what the other user is doing. These may include indications that the other user is currently composing a chat message, such as by displaying a change-looping icon in the chat area. Once the chat has been sent, it ceases to move. Another indicator may notify one user that the other user is currently composing a voice message, for example by a change loop next to a voice button for the duration that the other user holds down the microphone button.

The users may also be notified that the other user is drawing on a separate white board page. For instance, the tutor may start on page 1 with the student and move to page 3 to draw additional problems while the student finishes the problems on page 1. The tutor would see a blinking icon of page 1, indicating the student is actually performing work (drawing, answering questions), and the student would see a blinking icon of page 3 indicating the tutor is busy drawing or uploading more problems.

### Snapshots

At any time, the tutor can take a ‘snapshot’ of the whiteboard, which automatically creates a JPG of the entire screen, with images and all drawings over the top of the underlying image. Furthermore, at the conclusion of the tutoring session, the entire content created during the session may be captured as a snapshot. This may be automatically emailed to student, parent and tutor for reference in their next session, printed out for further review, or stored in a lesson summary to be viewed later by the student or parent. For example, if the student uploads a picture of their homework to the collaborative whiteboard during the session and completes their homework during the session, the student can take a snapshot of their completed homework at the end and then e-mail it to their teacher or print it out to bring to class.

These emails and snapshots can then be reviewed offline by the student, parent or tutor, and can be the basis for the next live session with the tutor and student.

These snapshots may appear in a playback timeline as special icons, indicating for instance that a snapshot was take at 10 minutes, 43 seconds into the session, allowing the parent, student or tutor to scroll through the playback timeline to that time and view the actual visual and audio record of that moment.

### Chat

In one embodiment, students and tutors can send short chat messages which appear in a separate section of the whiteboard interface and which may have a limited character maximum (in one embodiment, 127 characters). The chat messages may be placed in a vertical sidebar, which can be viewed or hidden at any time. If hidden, then only the latest chat appears to the side of the whiteboard.

### III. Real-Time Voice Exchange

In one embodiment, the users can communicate during a session via voice so that the student and tutor can carry on a conversation during the lesson. In one embodiment, the voice functionality is full duplex in real time to create a seamless conversation environment. The voice data may also be saved on the server for playback during the playback mode.

In one embodiment, voice communication is activated by a button on both tablets. It can either be pressed when needed, or placed in a ‘pushed down’ mode, meaning all voice is captured until the button is pressed ‘out.’ The audio data is captured and sent immediately to the other tablet in a point-to-point communication environment. In parallel, the audio data is also sent to the server for storage and future playback.

Each tablet device may therefore have both a point-to-point connection for streaming MP3 voice capture in near real-time, while in parallel sending those same dual voices in captured format to the server. There are two streams from each tablet, for a total of 4 parallel streams. The point-to-point data is played back by the other iPad, and then the data is dropped. The parallel streams send the same data from each respective tablet to the server, where it is compressed and stored permanently for playback.

The server, asynchronously, then compresses the voice and stores it in a database, along with the stamped milliseconds, for playback on any tablet at a later time. The voices of both tutor and student are therefore captured along with, and in sync with, all drawings, chats, photos, gestures, etc., so that the playback looks like how the original session was experienced by the Student.

### IV. Session Storage and Playback Mode

As has been briefly described above, one key feature of the system is the ability to store and then play back a previous session. This feature may typically be used by a parent to assess how well their child is doing, to ascertain the effectiveness of the tutor, to rank the tutor, and to learn what their child is working on, and even to review it again with their child. The student will like playback for its review capability, for refreshing their knowledge about their last session, before their next session, and for studying for a test.

In one embodiment, the following types of data may be stored for each session: all chat between student and tutor, based on actual timing; all whiteboard drawing between student and tutor based on timing; any uploaded images/photos that become new pages; any data drawn on top of them; any portions of images copied and pasted between pages (for instance, grabbing a rectangle around a particular problem from a photograph of homework problems can be grabbed and placed on the whiteboard or on a new page.); all voice between student and tutor, based on actual timings; and snapshots of screens from time to time, that can be emailed.

A Playback Mode consists of a selection process—choose the session to playback, and the speed to play it back. The session playback will download all content, along with millisecond timing information, to the tablet device up front. This will vary based on content, but generally the content is lightweight, except for potentially the recorded voice. In one embodiment the downloaded data may include: pages opened, drawings on each page, images uploaded as page backgrounds, chat and text, and voice recording snippets.

The voice snippets may be provided to reduce the file size of the file to be downloaded, as opposed to downloading the entire audio file of the entire session. The snippets may typically be 5 seconds to a maximum of 30 seconds. This can be medium fidelity, so assuming 1 MB for 30 seconds, the overall size of the content should be between 1 MB and 10-20 MB, depending the on the depth of the session, especially around voice. This will download within no more than 10-30 seconds on a typical network connection.

Once downloaded, the user (parent, tutor or student) can hit playback, with a full play/pause capability. If they are playing at 1× speed, the sound can be heard, otherwise any faster speed and only the other media is shown. The parent or student can pause or rewind at any time. The main goal is to allow a complete detailed review of the entire interactive session.

### V. Scheduling System

Scheduling a lesson by a student with a tutor involves a variety of choices from either the student or their parent. They need to choose (if they have more than one) their category/subcategory of study, then if they want a particular time of the week recurring, or just whatever tutor is available for that subcategory. In one embodiment, the options for types of scheduling may include the following:

### Recurring Weekly

The recurring weekly option is the most common method of setting up a lesson. They select their category/subcategory—for example, math, 8th grade, algebra I. The student (or parent) then selects a set of times throughout the week when they're available, for example, Monday 3-5 pm, Tuesday, 3-5 pm, Thursday 4-6 pm. Next, they see a list of tutors who teach that subcategory and have availability at those times. They can browse a list, drill down into tutors to see their background, and ultimately select one. This sets up the recurring lesson at the time of their choosing. The tutor can then see that they have a new student request for a lesson via an automated notification. When the tutor accepts, the student is notified.

### This Week Only (Non-Recurring)

Similar to the above, the user will choose a category and subcategory of subject, then choose times available during the week, then see list of tutors and select one. Only ONE session will be created for that tutor/student.

### Need Lesson Today

The “Need Lesson Today” option shows a grid of half hour increments to choose from for the remainder of the day from the tutors who are listed as available. They can then pick a tutor that's available, at least on the schedule, and wait for their response/confirmation.

### Need Lesson Now

The “Need Lesson Now” option means that the student needs a tutor immediately, i.e. within the next portion of the hour. The user is then prompted to pick from a list of available tutors after selecting the subject needed.

### Selecting a Tutor

When selecting a tutor and a session, the student may be provided with several options to help pick an appropriate tutor. For example, the student may have a “Use Default Tutor” option, which is the tutor that they will always default to, if they've set one up, a Favorites list of their tutors which will then produce the schedules of their favorite tutors, or an Availability List which lets them see any tutor that is available at that moment or for the time and date they've selected.

Once the student or parent selects a session and a tutor, a request is sent to the tutor indicating that a student is requesting a session. The tutor then needs to accept the lesson, although even if they don't, the student can still start that session when the time arrives.

A student may start a lesson up to 5 minutes before its scheduled time, and up to 20 minutes after the scheduled time, as can the tutor. This allows either user to ‘show up early’ and start uploading or drawing homework. If one party arrives earlier than the other, when the second person shows up, they will instantly see all the content drawn, or uploaded by the other person.

### VI. Tutor Rankings and Reviews

In one embodiment, students and parents can rank tutors at any time. Tutor ranking go from 1-5 stars, in half-star increments. Parents can see other parent rankings of tutors, and can share comments with each other anonymously, via their ‘screen name’ so as to remain anonymous. Tutors can ONLY see their own various rankings, but not on the date and time, nor student or parent. This is in order to ensure that they see their aggregate trend only, and do not know about individual rankings based on someone they are currently tutoring.

### VII. Payment

In one embodiment, the student and parent will pay for the sessions through a third party payment service which has already been set up with their banking or credit card information, such as their Apple account or Google Play account. In another embodiment, the student or parent may pay directly with a credit card or other electronic payment method through the application itself or through a webpage which handles the user's account information. A third party payment service such as PayPal may also be used.

The tutor may also be paid through the use of a third party payment service such as PayPal, which allows the funds to be transferred easily from one user to another (such as directly from the student/parent to the tutor) without requiring the tutoring system to handle or store payment information.

### VIII. Educational Content

Over time, we will build up standard content, for use by students or tutors, for instance ‘examples of Pre-Algebra, Chapter 1—positive and negative numbers’ can be chosen by either the student or tutor and this opens up a new page with space around the problems for solving. These may be implemented as digital worksheets which the tutor or the student can select from a menu and then have displayed on the whiteboard. In one embodiment, the worksheets may be provided to the student outside of the live tutoring session for completion in advance of the session, and the completed worksheets can then be displayed at the beginning of a tutoring session so the tutor can review the completed worksheet with the student.

### IX. System Architecture

In one embodiment, communication is done in a near real-time basis, with each tablet connecting to a central cloud server via web services, using the REST protocol. Each connected tablet both forwards its latest movements, drawings, images, voice annotations, text and so forth the server, and also polls several times a second for any new data to be downloaded from the other side. All polling times by each iPad are adjusted from several times a second, to less frequently, dynamically if we detect a slower connection.

Also, the transmission of session data may be dynamically adjusted, such that we will send larger packets of data less but frequently if we detect a slower connection.

Images can be both resized and compressed before sending. For instance, the iPad may take a 6 mega-pixel image, but it can be reduced significantly before sending for performance and payload optimization.

Fidelity can be adjusted dynamically as well. This means that although we may receive drawing messages from the iPad and capture movements (Bezier curves) at, for instance, 300 times a second, we may not send all of this data to the other tablet but will send a reduced fidelity version of the drawing gesture, whilst trying to maintain visual integrity. For instance, we may only send 100 Bezier curves to represent a user drawing a letter with their finger (or stylus), but the gesture, when replayed on the other side, will only lose a little bit of the fidelity of the actual curves, meaning to the human eye it will not look overly degraded.

The server maintains queues for each active session and makes data available in packets, so that each time a tablet polls looking for data, it receives all data since the last time it polled.

The data sharing is the highest priority for the server, meaning it ensures that data is sent between the linked tablets, and only persists all the data into the SQL database, as a lower priority background task.

All data from the session is then available for playback, review (by Parent or Student), and future data mining.

Data entities and descriptions of one embodiment are provided in the table below:

| | |
|---|---|
| User | Either a parent, student or tutor, 0 = parent, 1 = |
| | student , 2 = tutor. Students have a parent id (if |
| | under 18) and all parents have a student id. Both are |
| | separate rows in the database. Tutors are type 2, and |
| | have neither a student nor parent id. |
| Category | A Category of learning, for instance “Math”, |
| | “Biology” ALWAYS has subcategories |
| SubCategory | More specific such as “Math—8th grade— |
| | fractions” . . . etc. |
| TutorSchedule | Their weekly schedule, i.e. all half hour increments |
| | they're available across 7 days |
| UserCategory | A category selected by either the student for |
| | themselves, or a parent on behalf of the student, or if |
| | a tutor than what are their specialties |
| UserSubCategory | SubCategories (select one or more from above |
| | categories selected) for either a student or tutor |
| UserFavoriteTutors | Contains ids of their favorite tutors, in rank order |
| TutorRankings | All rankings, to determine a 1-5 star ranking in |
| | half-start increments. Stored as a decimal. Only |
| | students and parents can directly rank tutors. |
| | Sessions can also be ranked and are also reflective |
| | of the tutor. |
| AppleUserinfo | Any data needed for processing payments to |
| | TutorMob, whom in turn pay the tutors. |
| PayPalTutor | Tutors sign up for PayPal This stores their info |
| Lesson | This is setup by the student/parent and is a |
| | scheduled appointment. For instance 3 pm Tuesday I |
| | have a math/pre-algebra scheduled. It shows |
| | whether a tutor has been selected, whether it's under |
| | way . . . etc. |
| | Once under way, the ‘Session’ object (see below) is |
| | created which tracks connectivity between student |
| | and tutor, as well as houses all the data going back |
| | and forth. |
| Session | This object is created once either a student or tutor |
| | arrives for a Lesson (previously created, see above). |
| | It tracks all current status regarding connectivity, |
| | and if the student and tutor is still connected, last |
| | time we heard from either . . . etc. It is the parent |
| | object, for the duration of the lesson/session for all |
| | chats, voice, drawings, image uploads and pages. |
| SessionPage | A Start “Page 1” is always present for a new |
| | Session. It acts as the blank whiteboard. The student |
| | or tutor can then upload images (from a photo of |
| | their homework page for instance) which forms the |
| | background of “Page 2” . . . etc. and can then be |
| | drawn over. NOTE a SessionPage can exist on it's |
| | own (Page1 for instance) but a SessionImageUpload |
| | must always have a corresponding SessionPage |
| SessionImage | Images uploaded during the session. Most likely |
| | photographs that can be drawn on top of. They are |
| | corresponded with a SessionPage. |
| SessionChat | Chat's up to 255 characters can occur. Either tutor |
| | or student can tap Chat, and anything typed, up until |
| | the enter key, is then sent. (255 characters are sent |
| | automatically). |
| SessionDrawing | Contains discrete fields and proprietary XML |
| | content. Discrete fields include the sessionid, userid, |
| | and pagenumber it's associated with, along with the |
| | milliseconds since start of session (when finished) |
| | and order. These last two fields are stored expressly |
| | for playback purposes, and in case we queue up |
| | several Drawings and send them over all at once to |
| | the other receiving tablet. |
| SessionVoice | Some type of .wav file or equivalent, along with |
| | either student ID or Tutor Id, and datetime in |
| | milliseconds when it occurred as measure by the |
| | session. |

### X. Computer-Implemented Embodiment

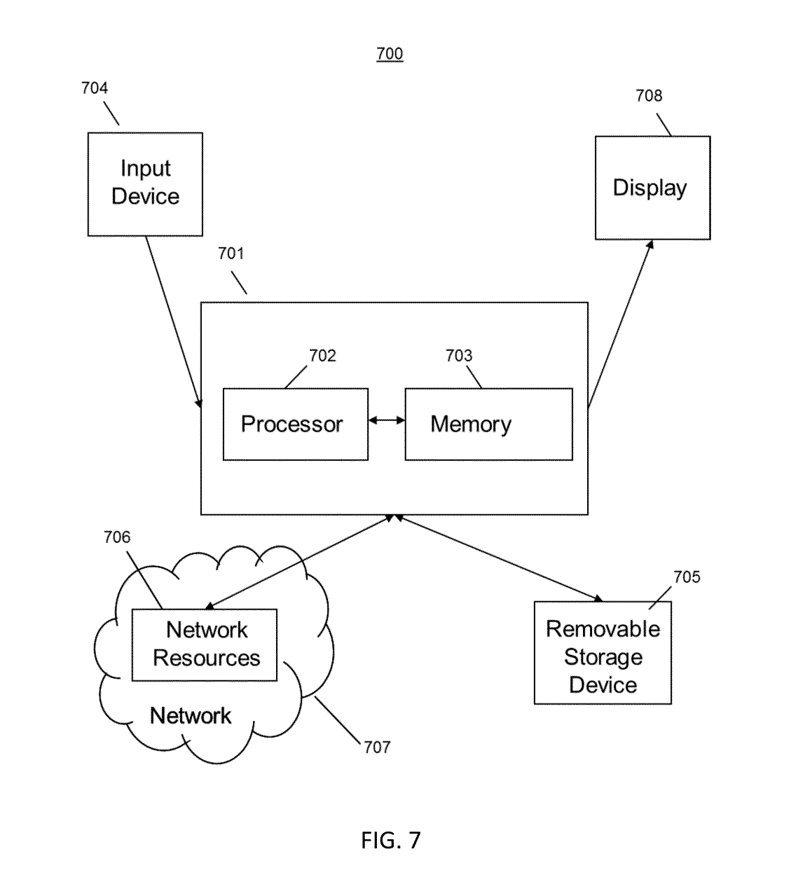

FIG. 7 is a block diagram that illustrates an embodiment of a computer/server system 700 upon which an embodiment of the inventive methodology may be implemented. The system 700 includes a computer/server platform 701 including a processor 702 and memory 703 which operate to execute instructions, as known to one of skill in the art. The term “computer-readable storage medium” as used herein refers to any tangible medium, such as a disk or semiconductor memory, that participates in providing instructions to processor 702 for execution. Additionally, the computer platform 701 receives input from a plurality of input devices 704, such as a keyboard, mouse, touch device or verbal command. The computer platform 701 may additionally be connected to a removable storage device 705, such as a portable hard drive, optical media (CD or DVD), disk media or any other tangible medium from which a computer can read executable code. The computer platform may further be connected to network resources 706 which connect to the Internet or other components of a local public or private network. The network resources 706 may provide instructions and data to the computer platform from a remote location on a network 707. The connections to the network resources 706 may be via wireless protocols, such as the 802.11 standards, Bluetooth® or cellular protocols, or via physical transmission media, such as cables or fiber optics. The network resources may include storage devices for storing data and executable instructions at a location separate from the computer platform 701. The computer interacts with a display 708 to output data and other information to a user, as well as to request additional instructions and input from the user. The display 708 may therefore further act as an input device 704 for interacting with a user.

### XI. Further Applications

The tablet-based real-time collaboration system is not limited to a tutoring session between a tutor and a student, but could be expanded to other applications where real-time, tablet-based collaboration between individuals in different locations is needed. The applications are not limited to education, and may include business meetings or personal use between parents and children. In one example, a healthcare provider may initiate a live collaborative session with a patient to explain instructions for medication, physical therapy or other health-related advice that can be illustrated and explained using the unique collaborative interface described herein.

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

1. A real-time tablet-based peer-to-peer tutoring system, comprising:
a student touchscreen device configured with an interactive display interface;
a tutor touchscreen device configured with the interactive display interface; and
a server configured to transmit interactions with the interactive display interfaces between the student touchscreen device and tutor touchscreen device in real time;
wherein the interactions include voice communication input to the student touchscreen device and tutor touchscreen device and physical inputs to the interactive display interfaces.

2. The system of claim 1, wherein the interactions are stored in sequence by the server.

3. The system of claim 1, wherein the interactions further include posting images to the interactive display interface.

4. The system of claim 1, wherein one or more interactions may be flagged for future review.

5. A method of real-time tablet-based peer-to-peer tutoring, comprising the steps of:
initiating an interactive real-time tutoring session between a student touchscreen device configured with an interactive display interface and a tutor touchscreen device configured with the interactive display interface;
transmitting interactions between the interactive display interface of the student touchscreen device and the tutor touchscreen device in real time using a server;
wherein the interactions include voice communication input to the student touchscreen device and tutor touchscreen device and physical inputs to the interactive display interfaces.

6. The method of claim 5, wherein the interactions are stored in sequence by the server.

7. The method of claim 5, wherein the interactions further include posting images to the interactive display interface.

8. The method of claim 5, wherein one or more interactions may be flagged for future review.
